(19) United States
(12) Patent Application Publication
(10) Pub. No.: US 2024/0331108 A1
(43) Pub. Date: Oct. 3, 2024

(54) DISPLAY CONDITION DECISION METHOD, DISPLAY CONDITION DECISION APPARATUS, AND PROGRAM

(71) Applicant: FUJIFILM Corporation, Tokyo (JP)

(72) Inventors: Yasunobu KISHINE, Saitama (JP); Takeshi WADA, Saitama (JP); Atsushi KAWANAGO, Saitama (JP); Kazuyoshi OKADA, Saitama (JP)

(73) Assignee: FUJIFILM Corporation, Tokyo (JP)

(21) Appl. No.: 18/596,644

(22) Filed: Mar. 6, 2024

(30) Foreign Application Priority Data
Mar. 30, 2023 (JP) 2023-056626

(51) Int. Cl. G06T 5/70; G06T 5/40; G06T 5/92; G06T 7/13; G06V 10/60

(52) U.S. Cl. CPC G06T 5/70; G06T 5/40; G06T 5/92; G06T 7/13; G06V 10/60; G06T 2207/10036; G06T 2207/20182; G06T 2207/20192

(57) ABSTRACT

A display condition decision method includes acquiring first imaging data including a first subject and a second subject imaged by a spectral imaging apparatus, acquiring first image data indicating an indicator related to discrimination between the first subject and the second subject from the first imaging data, and deciding a display condition of the first image data based on a relationship between the first subject and the second subject.

### CROSS-REFERENCE TO RELATED APPLICATIONS

This application claims priority under 35 USC 119 from Japanese Patent Application No. 2023-056626 filed on Mar. 30, 2023, the disclosure of which is incorporated by reference herein.

### BACKGROUND OF THE INVENTION

### 1. Field of the Invention

The technique of the present disclosure relates to a display condition decision method, a display condition decision apparatus, and a program.

### 2. Description of the Related Art

WO2016/133175A discloses a legume sorting system that analyzes an image obtained by imaging a legume with a pod, to examine or sort the legume. The legume sorting system comprises an image acquisition unit that acquires an image captured by an imaging unit, and an image analysis unit that analyzes the image acquired by the image acquisition unit. The image analysis unit executes a size examination of measuring a length of each legume and a width of each legume based on the captured image, and a number-of-grains examination of calculating the number of seeds accommodated in the legume based on the measured length of the legume.

WO2017/010258A discloses an examination apparatus comprising a correction gain calculation unit and a correction unit. The correction gain calculation unit calculates a correction gain of a spectrum based on reference spectrum information of a reference reflection plate or a reference transmission plate having characteristics corresponding to an examination object under a reference light source, and measurement spectrum information of the reference reflection plate or the reference transmission plate obtained by sensing under the measurement light source. The correction unit corrects the measurement spectrum information of the examination object obtained by the sensing under the measurement light source, based on the calculated correction gain.

JP2017-009396A discloses an imaging apparatus that captures an image of a plant and calculates a growth indicator of the plant based on the image. The imaging apparatus comprises a prism, an infrared cut filter, an optical filter, a first image sensor, a second image sensor, and an output unit. The prism splits reflected light incident from the plant through an incidence surface, and emits the split reflected light from at least a first emission surface and a second emission surface. The infrared cut filter is disposed to face the first emission surface and is used to capture a visible light image of the plant. The optical filter is disposed to face the second emission surface and is used to capture an image used for calculation of the growth indicator of the plant. The first image sensor receives the emitted light from the first emission surface through the infrared cut filter and captures the visible light image. The second image sensor receives the emitted light from the second emission surface through the optical filter and captures the image used for the calculation of the growth indicator of the plant. The output unit outputs the visible light image and the image used for the calculation of the growth indicator of the plant.

WO2016/208415A discloses an examination apparatus comprising a detection unit and a controller. The detection unit detects components in a plurality of different wavelength ranges of reflected light obtained by reflecting ambient light from an examination object that is a target of the examination. The controller controls the sensitivity for each component in the plurality of different wavelength ranges.

JP2013-238579A discloses a grain component analysis apparatus that quantitatively analyzes a specific component contained in a grain by a spectroscopic method on a grain unit basis. The grain component analysis apparatus comprises a light emitting unit, a spectrum detection unit, and a calculation unit. The light emitting unit irradiates the grain as an analysis target with light. The spectrum detection unit detects a spectrum of transmitted light and/or reflected light from the grain irradiated with the light. The calculation unit calculates a content of the specific component of the grain from a spectrum value detected from an effective portion suitable for the quantitative analysis of the image of the grain on the grain unit basis by using a calibration curve showing a relationship between the spectrum value at a specific wavelength and the content of the specific component for the analysis target grain.

### SUMMARY OF THE INVENTION

One embodiment according to the technique of the present disclosure provides a display condition decision method, a display condition decision apparatus, and a program that can discriminate a difference between a first subject and a second subject as compared with a case in which, for example, a display range is fixed to a predetermined display range.

A first aspect according to the technique of the present disclosure relates to a display condition decision method comprising: acquiring first imaging data including a first subject and a second subject imaged by a spectral imaging apparatus; acquiring first image data indicating an indicator related to discrimination between the first subject and the second subject from the first imaging data; and deciding a display condition of the first image data based on a relationship between the first subject and the second subject.

A second aspect according to the technique of the present disclosure relates to the display condition decision method according to the first aspect, in which the display condition includes a display range.

A third aspect according to the technique of the present disclosure relates to the display condition decision method according to the first or second aspect, in which the indicator is an indicator based on a brightness of light in a plurality of wavelength ranges.

A fourth aspect according to the technique of the present disclosure relates to the display condition decision method according to the third aspect, in which the plurality of wavelength ranges are selected from a combination.

A fifth aspect according to the technique of the present disclosure relates to the display condition decision method according to the third or fourth aspect, in which the plurality of wavelength ranges are selected based on attributes of the first subject and the second subject.

A sixth aspect according to the technique of the present disclosure relates to the display condition decision method according to any one of the third to fifth aspects, in which the plurality of wavelength ranges are selected based on imaging conditions of the first subject and the second subject.

A seventh aspect according to the technique of the present disclosure relates to the display condition decision method according to the sixth aspect, in which the imaging condition includes a lighting condition.

An eighth aspect according to the technique of the present disclosure relates to the display condition decision method according to any one of the first to seventh aspects, in which the indicator includes a contrast of a brightness of light in a plurality of wavelength ranges.

A ninth aspect according to the technique of the present disclosure relates to the display condition decision method according to any one of the first to eighth aspects, in which the indicator includes a normalized difference vegetation index.

A tenth aspect according to the technique of the present disclosure relates to the display condition decision method according to any one of the first to ninth aspects, in which the relationship includes a relationship between the first subject and the second subject in an image indicated by the first image data.

An eleventh aspect according to the technique of the present disclosure relates to the display condition decision method according to the tenth aspect, in which the relationship between the first subject and the second subject in the image includes a relationship in a state in which the image includes noise.

A twelfth aspect according to the technique of the present disclosure relates to the display condition decision method according to any one of the first to eleventh aspects, in which the relationship includes attributes of the first subject and the second subject.

A thirteenth aspect according to the technique of the present disclosure relates to the display condition decision method according to any one of the first to twelfth aspects, in which the relationship includes imaging conditions of the first subject and the second subject.

A fourteenth aspect according to the technique of the present disclosure relates to the display condition decision method according to any one of the first to thirteenth aspects, in which the relationship includes a relationship of the indicator between the first subject and the second subject.

A fifteenth aspect according to the technique of the present disclosure relates to the display condition decision method according to the fourteenth aspect, in which the indicator includes a first indicator corresponding to the first subject, and a second indicator corresponding to the second subject, and the relationship of the indicator includes a relationship based on a degree of difference between the first indicator and the second indicator.

A sixteenth aspect according to the technique of the present disclosure relates to the display condition decision method according to any one of the tenth aspect, the eleventh to fourteenth aspects citing the tenth aspect, or the fifteenth aspect, in which the relationship includes a relationship in a state in which image processing is executed on the image.

A seventeenth aspect according to the technique of the present disclosure relates to the display condition decision method according to the sixteenth aspect, in which the image processing includes processing related to noise included in the image.

An eighteenth aspect according to the technique of the present disclosure relates to the display condition decision method according to the seventeenth aspect, in which the processing related to the noise includes edge enhancement processing and/or noise reduction processing.

A nineteenth aspect according to the technique of the present disclosure relates to the display condition decision method according to any one of the tenth aspect, the eleventh to fourteenth aspects citing the tenth aspect, or the fifteenth to eighteenth aspects, in which the relationship includes a relationship in a state in which arithmetic processing is executed on the image.

A twentieth aspect according to the technique of the present disclosure relates to the display condition decision method according to the nineteenth aspect, in which the arithmetic processing includes processing related to visibility of the image.

A twenty-first aspect according to the technique of the present disclosure relates to the display condition decision method according to the twentieth aspect, in which the processing related to the visibility includes gradation processing and/or gamma-correction processing.

A twenty-second aspect according to the technique of the present disclosure relates to the display condition decision method according to any one of the first to twenty-first aspects, in which the relationship includes a relationship between the first subject and the second subject with respect to a subject imaged in the past by the spectral imaging apparatus.

A twenty-third aspect according to the technique of the present disclosure relates to the display condition decision method according to any one of the first to twenty-second aspects, in which deciding the display condition includes selecting the display condition from among a plurality of display conditions based on the relationship.

A twenty-fourth aspect according to the technique of the present disclosure relates to the display condition decision method according to the twenty-third aspect, in which the indicator includes a first indicator corresponding to the first subject, and a second indicator corresponding to the second subject, the relationship includes a relationship based on a degree of difference between the first indicator and the second indicator, and selecting the display condition from among the plurality of display conditions is performed based on a relationship between the degree of difference and a threshold value.

A twenty-fifth aspect according to the technique of the present disclosure relates to the display condition decision method according to the twenty-fourth aspect, in which, in a case in which the degree of difference is larger than the threshold value, an upper limit value of the display condition is decided based on a larger indicator out of the first indicator and the second indicator, and a lower limit value of the display condition is decided based on a smaller indicator out of the first indicator and the second indicator.

A twenty-sixth aspect according to the technique of the present disclosure relates to the display condition decision method according to the twenty-fifth aspect, in which the upper limit value of the display condition is decided based on the larger indicator and a first correction value, and the lower limit value of the display condition is decided based on the smaller indicator and a second correction value.

A twenty-seventh aspect according to the technique of the present disclosure relates to the display condition decision method according to the twenty-sixth aspect, in which the first correction value and the second correction value are decided based on noise included in an image indicated by the first image data.

A twenty-eighth aspect according to the technique of the present disclosure relates to the display condition decision method according to any one of the twenty-fourth to twenty-seventh aspects, in which, in a case in which the degree of difference is equal to or smaller than the threshold value, a difference between an upper limit value and a lower limit value of the display condition is decided as the threshold value.

A twenty-ninth aspect according to the technique of the present disclosure relates to the display condition decision method according to the twenty-eighth aspect, in which the upper limit value and the lower limit value of the display condition are decided based on an average value of the first indicator and the second indicator.

A thirtieth aspect according to the technique of the present disclosure relates to the display condition decision method according to the twenty-ninth aspect, in which the upper limit value of the display condition is decided based on the average value and a third correction value, and the lower limit value of the display condition is decided based on the average value and a fourth correction value.

A thirty-first aspect according to the technique of the present disclosure relates to the display condition decision method according to the thirtieth aspect, in which the third correction value and the fourth correction value are decided based on noise included in an image indicated by the first image data.

A thirty-second aspect according to the technique of the present disclosure relates to the display condition decision method according to any one of the first to thirty-first aspects, in which the spectral imaging apparatus is a multispectral camera.

A thirty-third aspect according to the technique of the present disclosure relates to the display condition decision method according to the thirty-second aspect, in which the first imaging data includes spectral image data corresponding to light in a plurality of wavelength ranges.

A thirty-fourth aspect according to the technique of the present disclosure relates to the display condition decision method according to any one of the first to thirty-third aspects, in which the second subject is a subject having a larger indicator than the first subject.

A thirty-fifth aspect according to the technique of the present disclosure relates to the display condition decision method according to any one of the first to thirty-fourth aspects, in which the first image data is image data in which the indicator is displayed by a heat map.

A thirty-sixth aspect according to the technique of the present disclosure relates to the display condition decision method according to any one of the first to thirty-fifth aspects, in which acquiring the first image data is performed based on a selected region of the first subject and/or the second subject.

A thirty-seventh aspect according to the technique of the present disclosure relates to the display condition decision method according to any one of the first to thirty-sixth aspects, in which the discrimination includes discrimination of goodness or badness of the first subject and the second subject.

A thirty-eighth aspect according to the technique of the present disclosure relates to a display condition decision apparatus comprising: a processor, in which the processor acquires first imaging data including a first subject and a second subject imaged by a spectral imaging apparatus, acquires first image data indicating an indicator related to discrimination between the first subject and the second subject from the first imaging data, and decides a display condition of the first image data based on a relationship between the first subject and the second subject.

A thirty-ninth aspect according to the technique of the present disclosure relates to the display condition decision apparatus according to the thirty-eighth aspect, in which the processor acquires values of a plurality of timers related to calibration of the spectral imaging apparatus, and outputs update data related to update of the calibration based on the values.

A fortieth aspect according to the technique of the present disclosure relates to the display condition decision apparatus according to the thirty-eighth or thirty-ninth aspect, in which the processor outputs histogram data related to the indicator based on the first imaging data.

A forty-first aspect according to the technique of the present disclosure relates to the display condition decision apparatus according to the fortieth aspect, in which the histogram data includes first histogram data indicating a ratio of the indicator.

A forty-second aspect according to the technique of the present disclosure relates to the display condition decision apparatus according to the fortieth or forty-first aspect, in which the histogram data includes second histogram data indicating a ratio of a brightness of a wavelength component of light emitted from the first subject and/or the second subject.

A forty-third aspect according to the technique of the present disclosure relates to the display condition decision apparatus according to any one of the fortieth to forty-second aspects, in which the histogram data is displayed based on a selected region of the first subject and/or the second subject.

A forty-fourth aspect according to the technique of the present disclosure relates to a program for causing a computer to execute a process comprising: acquiring first imaging data including a first subject and a second subject imaged by a spectral imaging apparatus; acquiring first image data indicating an indicator related to discrimination between the first subject and the second subject from the first imaging data; and deciding a display condition of the first image data based on a relationship between the first subject and the second subject.

### BRIEF DESCRIPTION OF THE DRAWINGS

FIG. 1 is a block diagram showing an example of an examination system.

FIG. 2 is a perspective view showing an example of an imaging apparatus.

FIG. 3 is an exploded perspective view showing an example of a pupil split filter.

FIG. 4 is a block diagram showing an example of a hardware configuration of the imaging apparatus.

FIG. 5 is an exploded perspective view showing an example of a part of a photoelectric conversion element.

FIG. 6 is a block diagram showing an example of a functional configuration of the imaging apparatus.

FIG. 7 is a block diagram showing an example of operations of an output value acquisition unit and an interference removal processing unit.

FIG. 8 is a block diagram showing an example of a functional configuration for executing examination processing in a processing apparatus according to a first embodiment.

FIG. 9 is a block diagram showing an example of operations of an imaging data acquisition unit, a wavelength range selection unit, and an image processing unit in the processing apparatus according to the first embodiment.

FIG. 10 is a block diagram showing an example of operations of an image region selection unit, an image data acquisition unit, and a display controller in the processing apparatus according to the first embodiment.

FIG. 11 is an explanatory diagram showing a first example of a case in which a display range is made different for a contrast map including a first subject and a second subject.

FIG. 12 is an explanatory diagram showing a second example in which the display range is made different for the contrast map including the first subject and the second subject.

FIG. 13 is an explanatory diagram showing a third example in a case in which the display range is made different for the contrast map including the first subject and the second subject.

FIG. 14 is a block diagram showing an example of a functional configuration for executing display range decision processing in the processing apparatus according to the first embodiment.

FIG. 15 is a block diagram showing an example of the operation of the imaging data acquisition unit in the processing apparatus according to the first embodiment.

FIG. 16 is a block diagram showing an example of the operations of the imaging data acquisition unit, the wavelength range selection unit, and the image processing unit in the processing apparatus according to the first embodiment.

FIG. 17 is a block diagram showing an example of operations of the image region selection unit, the image data acquisition unit, and a display range decision unit in the processing apparatus according to the first embodiment.

FIG. 18 is a block diagram showing an example of the operations of the image data acquisition unit, the display range decision unit, and the display controller in the processing apparatus according to the first embodiment.

FIG. 19 is a block diagram showing an example of the operations of the image data acquisition unit, the display range decision unit, and the display controller in the processing apparatus according to the first embodiment.

FIG. 20 is a flowchart showing an example of a flow of spectral image generation processing.

FIG. 21 is a flowchart showing an example of a flow of the display range decision processing.

FIG. 22 is a flowchart showing an example of a flow of the examination processing.

FIG. 23 is a block diagram showing an example of operations of an image region selection unit, a slider generation unit, a histogram generation unit, and a display controller in the processing apparatus according to a second embodiment.

FIG. 24 is a flowchart showing an example of a flow of histogram generation processing.

FIG. 25 is a block diagram showing an example of operations of a first timer, a second timer, and a calibration update unit in the processing apparatus according to a third embodiment.

FIG. 26 is a flowchart showing an example of a flow of calibration update processing.

### DESCRIPTION OF THE PREFERRED EMBODIMENTS

Hereinafter, an example of embodiments of a display condition decision method, a display condition decision apparatus, and a program according to the technique of the present disclosure will be described with reference to the accompanying drawings.

First, the terms used in the following description will be described.

LED is an abbreviation for “Light Emitting Diode”. NDVI is an abbreviation for “Normalized Difference Vegetation Index”. RGB is an abbreviation for “Red Green Blue”. EL is an abbreviation for “Electro Luminescence”. CMOS is an abbreviation for “Complementary Metal Oxide Semiconductor”. CCD is an abbreviation for “Charge Coupled Device”. I/F is an abbreviation for “Interface”. RAM is an abbreviation for “Random Access Memory”. CPU is an abbreviation for “Central Processing Unit”. GPU is an abbreviation for “Graphics Processing Unit”. EEPROM is an abbreviation for “Electrically Erasable and Programmable Read Only Memory”. HDD is an abbreviation for “Hard Disk Drive”. DRAM is an abbreviation for “Dynamic Random Access Memory”. SRAM is an abbreviation for “Static Random Access Memory”. TPU is an abbreviation for “Tensor Processing Unit”. SSD is an abbreviation for “Solid State Drive”. USB is an abbreviation for “Universal Serial Bus”. ASIC is an abbreviation for “Application Specific Integrated Circuit”. FPGA is an abbreviation for “Field-Programmable Gate Array”. PLD is an abbreviation for “Programmable Logic Device”. SoC is an abbreviation for “System-on-a-Chip”. IC is an abbreviation for “Integrated Circuit”. IR is an abbreviation for “Infrared Rays”.

In the description of the present specification, “the same” refers to the same in the sense of including an error generally allowed in the technical field to which the technique of the present disclosure belongs, which is the error to the extent that it does not contradict the purpose of the technique of the present disclosure, in addition to the exact same. In the description of the present specification, “orthogonal” refers to the orthogonality in the sense of including an error generally allowed in the technical field to which the technique of the present disclosure belongs, that is, an error to the extent that it does not contradict the gist of the technique of the present disclosure, in addition to the exact orthogonality. In the description of the present specification, “straight line” refers to the straight line in the sense of including an error generally allowed in the technical field to which the technique of the present disclosure belongs, that is, an error to the extent that it does not contradict the gist of the technique of the present disclosure, in addition to the exact straight line.

### First Embodiment

First, a first embodiment of the technique of the present disclosure will be described.

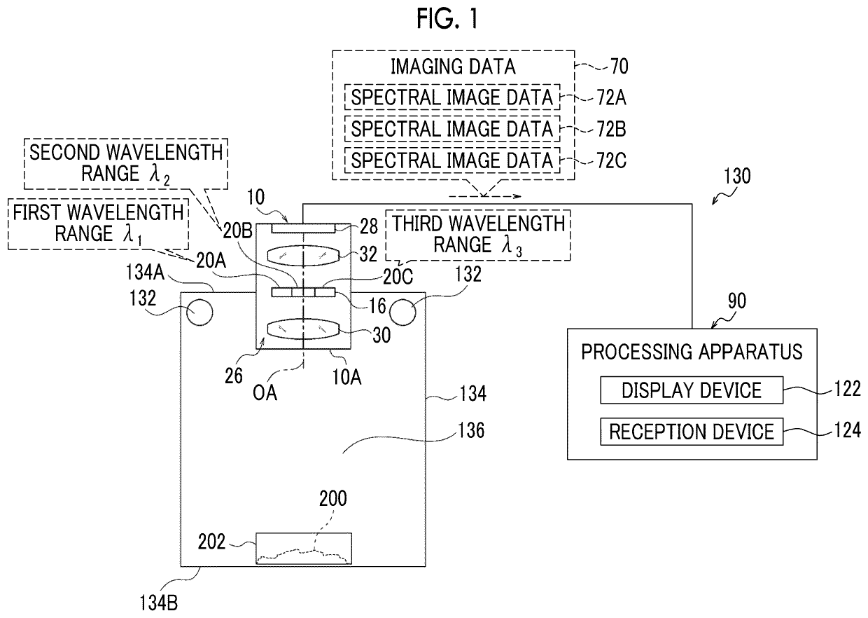

As an example, as shown in FIG. 1, an examination system 130 according to the first embodiment comprises a plurality of light sources 132, a housing 134, an imaging apparatus 10, and a processing apparatus 90. The processing apparatus 90 is an example of a “display condition decision apparatus” according to the technique of the present disclosure.

The plurality of light sources 132 are, for example, LED light sources, laser light sources, and incandescent bulbs. The light applied from the plurality of light sources 132 is unpolarized light. The plurality of light sources 132 are disposed in an upper portion inside the housing 134 as an example. The number of the plurality of light sources 132 may be optional, and one light source 132 may be used instead of the plurality of light sources 132.

The housing 134 has a configuration of covering an imaging space 136. The plurality of light sources 132, an incident portion 10A of the imaging apparatus 10, and a subject 200 are disposed in the imaging space 136. The imaging apparatus 10 is provided in a ceiling portion 134A of the housing 134. The subject 200 is disposed in a bottom portion 134B of the housing 134. The subject 200 is, for example, a plurality of seeds placed in a transparent petri dish 202. Hereinafter, the description will be made on the premise that the subject 200 is the plurality of seeds. It should be noted that the subject 200 may be a plant other than the seed or may be anything other than the plant.

The plurality of seeds include a good seed and a bad seed. The goodness or badness of the seed is evaluated using, for example, a normalized difference vegetation index NDVI. The seed of which the normalized difference vegetation index is equal to or larger than a predetermined threshold value is decided as a good seed, and the seed of which the normalized difference vegetation index is smaller than the predetermined threshold value is decided as a bad seed. The predetermined threshold value for deciding the goodness or badness of the seed can be set to any value based on the variety of the seed and the like.

The imaging apparatus 10 is, for example, a multispectral camera. Here, although an example is described in which the imaging apparatus 10 is the multispectral camera, the imaging apparatus 10 may be a spectral camera, such as a hyperspectral camera. In addition, the imaging apparatus 10 may be an RGB camera with a spectral filter. In addition, the imaging apparatus 10 may be a camera that performs imaging a plurality of times while switching lightings having different wavelengths. Hereinafter, as an example, a case will be described in which the imaging apparatus 10 is a multispectral camera. The imaging apparatus 10 is an example of an “spectral imaging apparatus” according to the technique of the present disclosure.

The imaging apparatus 10 comprises an optical system 26 and an image sensor 28. The optical system 26 comprises a first lens 30, a pupil split filter 16, and a second lens 32. The first lens 30, the pupil split filter 16, and the second lens 32 are disposed in order of the first lens 30, the pupil split filter 16, and the second lens 32 along an optical axis OA from the subject 200 side to the image sensor 28 side.

The pupil split filter 16 includes spectral filters 20A to 20C. Each of the spectral filters 20A to 20C is a bandpass filter that transmits light in a specific wavelength range. The spectral filters 20A to 20C have wavelength ranges that are different from each other. Specifically, the spectral filter 20A has a first wavelength range λ₁, the spectral filter 20B has a second wavelength range λ₂, and the spectral filter 20C has a third wavelength range λ₃.

Hereinafter, in a case in which it is not necessary to distinguish among the spectral filters 20A to 20C, each of the spectral filters 20A to 20C will be referred to as “spectral filter 20”. In addition, in a case in which it is not necessary to distinguish among the first wavelength range λ₁, the second wavelength range λ₂, and the third wavelength range λ₃, each of the first wavelength range λ₁, the second wavelength range λ₂, and the third wavelength range λ₃ will be referred to as “wavelength range λ”.

In the imaging apparatus 10, as will be described in detail below, spectral image data 72A to 72C corresponding to each wavelength range λ are generated based on imaging data 70 obtained by imaging the subject 200. The spectral image data 72A is spectral image data corresponding to the first wavelength range λ₁, the spectral image data 72B is spectral image data corresponding to the second wavelength range λ₂, and the spectral image data 72C is spectral image data corresponding to the third wavelength range λ₃. Hereinafter, in a case in which it is not necessary to distinguish among the spectral image data 72A to 72C, each of the spectral image data 72A to 72C will be referred to as “spectral image data 72”.

In the first embodiment, as an example, a case will be described in which three spectral image data 72 are generated based on light divided into three wavelength ranges λ. The three wavelength ranges λ are merely an example, and two or more wavelength ranges λ may be used.

The imaging apparatus 10 has a zoom function. In a case in which the subject 200 is imaged by the imaging apparatus 10, an angle of view of the imaging apparatus 10 is adjusted by the zoom function. The angle of view of the imaging apparatus 10 is set to an angle of view in which the subject 200 is included in an imaging range of the imaging apparatus 10.

The processing apparatus 90 is communicably connected to the imaging apparatus 10. The processing apparatus 90 is, for example, an information processing apparatus, such as a personal computer or a server. The processing apparatus 90 comprises a display device 122 and a reception device 124. The display device 122 is, for example, a liquid crystal display or an EL display. The reception device 124 comprises, for example, a keyboard, a mouse, and a touch pad. As will be described in detail below, the processing apparatus 90 executes an examination on the subject 200 based on the information received by the reception device 124, the imaging data received from the imaging apparatus 10, and the like, and displays a result of the examination and/or the image on the display device 122.

Hereinafter, the imaging apparatus 10 according to the first embodiment will be described in detail.

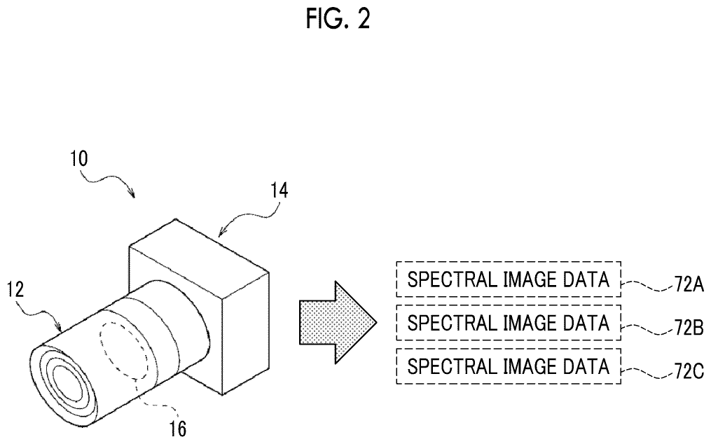

For example, as shown in FIG. 2, the imaging apparatus 10 comprises a lens device 12 and an imaging apparatus body 14. The lens device 12 includes a pupil split filter 16. As described above, the imaging apparatus 10 is the multispectral camera that generates and outputs a plurality of spectral image data 72A to 72C by imaging the light divided into the plurality of wavelength ranges λ by the pupil split filter 16.

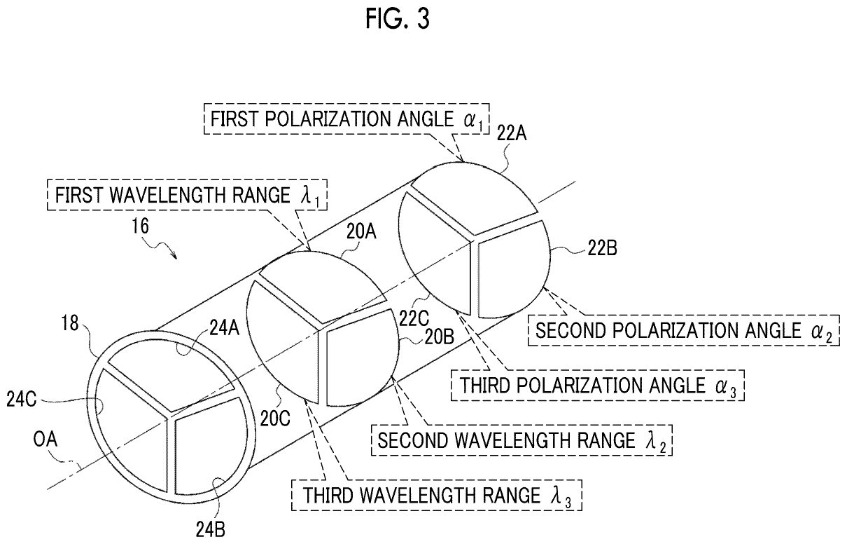

As an example, as shown in FIG. 3, the pupil split filter 16 includes a frame 18, the spectral filters 20A to 20C, and polarizing filters 22A to 22C.

The frame 18 has openings 24A to 24C. The openings 24A to 24C are arranged and formed around the optical axis OA. Hereinafter, in a case in which it is not necessary to distinguish among the openings 24A to 24C, each of the openings 24A to 24C will be referred to as “opening 24”. The spectral filters 20A to 20C are provided in the openings 24A to 24C, respectively, and are arranged around the optical axis OA. Accordingly, a centroid position of each of the spectral filters 20A to 20C is located at a position different from the optical axis OA.

The polarizing filters 22A to 22C are provided corresponding to the spectral filters 20A to 20C, respectively. Specifically, the polarizing filter 22A is provided in the opening 24A and is superimposed on the spectral filter 20A. The polarizing filter 22B is provided in the opening 24B and is superimposed on the spectral filter 20B. The polarizing filter 22C is provided in the opening 24C and is superimposed on the spectral filter 20C.

Each of the polarizing filters 22A to 22C is an optical filter that transmits light that vibrates in a specific direction. The polarizing filters 22A to 22C have polarization axes having polarization angles different from each other. Specifically, the polarizing filter 22A has a first polarization angle α₁, the polarizing filter 22B has a second polarization angle α₂, and the polarizing filter 22C has a third polarization angle α₃. It should be noted that the polarization axis may be referred to as a transmission axis. As an example, the first polarization angle α₁ is set to 0°, the second polarization angle α₂ is set to 45°, and the third polarization angle α₃ is set to 90°.

Hereinafter, in a case in which it is not necessary to distinguish among the polarizing filters 22A to 22C, each of the polarizing filters 22A to 22C will be referred to as “polarizing filter 22”. In addition, in a case in which it is not necessary to distinguish among the first polarization angle α₁, the second polarization angle α₂, and the third polarization angle α₃, each of the first polarization angle α₁, the second polarization angle α₂, and the third polarization angle α₃ will be referred to as “polarization angle α”.

It should be noted that, in the example shown in FIG. 3, the number of a plurality of openings 24 is three corresponding to the number of the plurality of wavelength ranges λ, but the number of the plurality of openings 24 may be more than the number of the plurality of wavelength ranges λ (that is, the number of the plurality of spectral filters 20). In addition, the opening 24 that is not used among the plurality of openings 24 may be closed by a shielding member (not shown). In addition, in the example shown in FIG. 3, the plurality of spectral filters 20 have the wavelength ranges λ different from each other, but the plurality of spectral filters 20 may include the spectral filters 20 having the same wavelength range λ.

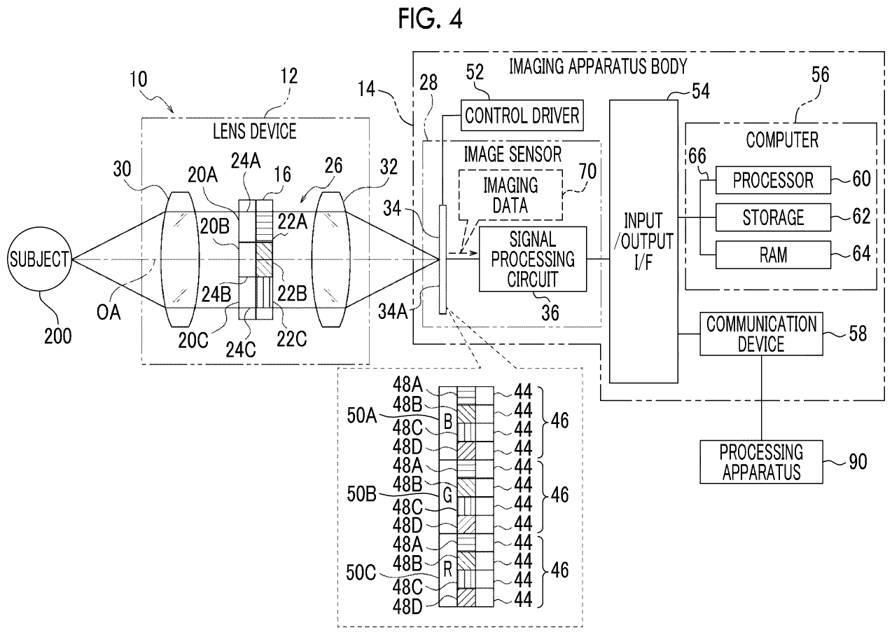

As an example, as shown in FIG. 4, the lens device 12 comprises an optical system 26, and the imaging apparatus body 14 comprises an image sensor 28. The optical system 26 includes the pupil split filter 16, a first lens 30, and a second lens 32.

The first lens 30 causes light reflected by the subject 200 to be incident on the pupil split filter 16. The second lens 32 forms an image of the light transmitted through the pupil split filter 16 on a light-receiving surface 34A of a photoelectric conversion element 34 provided in the image sensor 28.

The pupil split filter 16 is disposed at a pupil position of the optical system 26. The pupil position refers to a stop surface that limits the lightness of the optical system 26. The pupil position here also includes a near position, and the near position refers to a range from an incidence pupil to an exit pupil. A configuration of the pupil split filter 16 is as described with reference to FIG. 3. In FIG. 4, for convenience, the plurality of spectral filters 20 and the plurality of polarizing filters 22 are shown in a state of being arranged in a straight line along a direction orthogonal to the optical axis OA.

The image sensor 28 comprises the photoelectric conversion element 34 and a signal processing circuit 36. The image sensor 28 is, for example, a CMOS image sensor. In the first embodiment, although the CMOS image sensor is shown as the image sensor 28, the technique of the present disclosure is not limited to this. For example, the technique of the present disclosure is also established even in a case in which the image sensor 28 is another type of image sensor, such as a CCD image sensor.

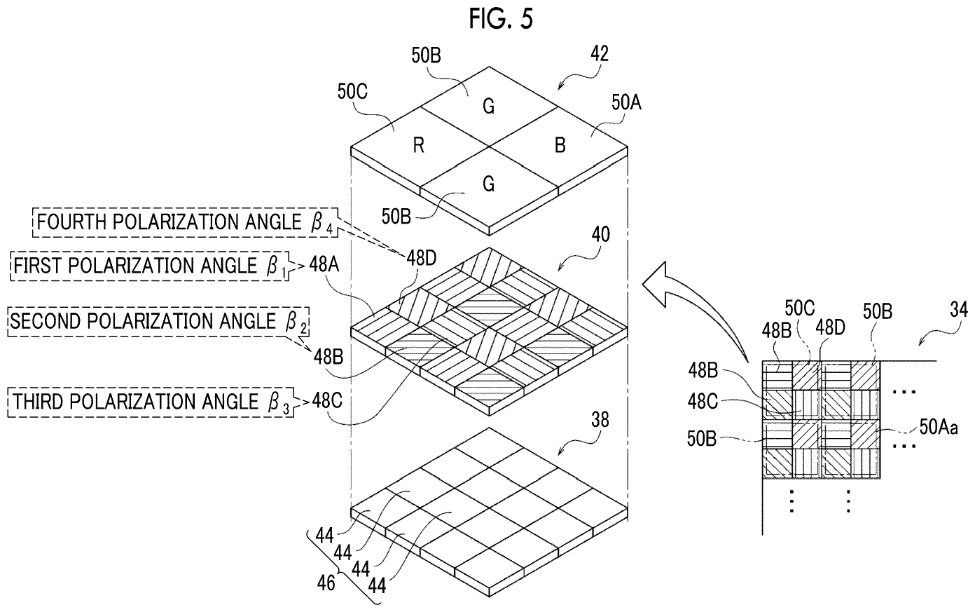

As an example, a schematic configuration of the photoelectric conversion element 34 is shown in FIG. 4. In addition, as an example, a configuration of a part of the photoelectric conversion element 34 is specifically shown in FIG. 5. The photoelectric conversion element 34 has a pixel layer 38, a polarizing filter layer 40, and a spectral filter layer 42. It should be noted that the configuration of the photoelectric conversion element 34 shown in FIG. 5 is an example, and the technique of the present disclosure is established even in a case in which the photoelectric conversion element 34 does not have the spectral filter layer 42.

The pixel layer 38 includes a plurality of pixels 44. The plurality of pixels 44 are disposed in a matrix to form the light-receiving surface 34A of the photoelectric conversion element 34. Each pixel 44 is a physical pixel having a photodiode (not shown), which photoelectrically converts the received light and outputs an electric signal in accordance with a light-receiving amount.

Hereinafter, the pixel 44 provided in the photoelectric conversion element 34 will be referred to as “physical pixel 44” in order to distinguish from the pixel that forms a spectral image indicated by the spectral image data 72. In addition, the pixel that forms the spectral image will be referred to as “image pixel”.

The photoelectric conversion element 34 outputs the electric signals output from a plurality of physical pixels 44 to the signal processing circuit 36 as the imaging data. The signal processing circuit 36 digitizes analog imaging data 70 input from the photoelectric conversion element 34. The imaging data 70 is image data indicating a captured image.

The plurality of physical pixels 44 form a plurality of pixel blocks 46. Each pixel block 46 is formed of four physical pixels 44, which are two in a vertical direction and two in a horizontal direction. In FIG. 4, for convenience, the four physical pixels 44 forming each pixel block 46 are shown in a state of being arranged in a straight line along the direction orthogonal to the optical axis OA, but the four physical pixels 44 are disposed adjacent to each other in the vertical direction and the horizontal direction of the photoelectric conversion element 34 (see FIG. 5).

The polarizing filter layer 40 includes a plurality of types of polarizers 48A to 48D. Each of the polarizers 48A to 48D is an optical filter that transmits the light that vibrates in the specific direction. The polarizers 48A to 48D have polarization axes having polarization angles different from each other. Specifically, the polarizer 48A has a first polarization angle β₁, the polarizer 48B has a second polarization angle β₂, the polarizer 48C has a third polarization angle β₃, and the polarizer 48D has a fourth polarization angle β₄. As an example, the first polarization angle β₁ is set to 0°, the second polarization angle β₂ is set to 45°, the third polarization angle β₃ is set to 90°, and the fourth polarization angle β₄ is set to 135°.

Hereinafter, in a case in which it is not necessary to distinguish among the polarizers 48A to 48D, each of the polarizers 48A to 48D will be referred to as “polarizer 48”. In addition, in a case in which it is not necessary to distinguish among the first polarization angle β₁, the second polarization angle β₂, the third polarization angle β₃, and the fourth polarization angle β₄, each of the first polarization angle β₁, the second polarization angle β₂, the third polarization angle β₃, and the fourth polarization angle β₄ will be referred to as “polarization angle β”.

The spectral filter layer 42 includes a B filter 50A, a G filter 50B, and an R filter 50C. The B filter 50A is a blue color filter that most transmits light in a blue wavelength range in the light in the plurality of wavelength ranges. The G filter 50B is a green filter that most transmits light in a green wavelength range in the light in the plurality of wavelength ranges. The R filter 50C is a red filter that most transmits light in a red wavelength range in the light in the plurality of wavelength ranges. The B filter 50A, the G filter 50B, and the R filter 50C are assigned to each pixel block 46. It should be noted that, although the spectral filter layer 42 generally has an IR cut filter (not shown), in a case in which the imaging apparatus 10 images near-infrared light, it is preferable to remove the IR cut filter.

In FIG. 4, for convenience, the B filter 50A, the G filter 50B, and the R filter 50C are shown in a state of being arranged in a straight line along the direction orthogonal to the optical axis OA. However, as shown in FIG. 5 as an example, the B filter 50A, the G filter 50B, and the R filter 50C are disposed in a matrix in a predetermined pattern array. In the example shown in FIG. 5, the B filter 50A, the G filter 50B, and the R filter 50C are disposed in a matrix in a Bayer array as an example of the predetermined pattern array. It should be noted that, in addition to the Bayer array, the predetermined pattern array may be an RGB stripe array, an R/G checker array, an X-Trans (registered trademark) array, a honeycomb array, and the like. Hereinafter, in a case in which it is not necessary to distinguish among the B filter 50A, the G filter 50B, and each of the R filter 50C, the B filter 50A, the G filter 50B, and the R filter 50C will be referred to as “filter 50”.

As shown in FIG. 4 as an example, the imaging apparatus body 14 comprises a control driver 52, an input/output I/F 54, a computer 56, and a communication device 58, in addition to the image sensor 28. The signal processing circuit 36, the control driver 52, the computer 56, and the communication device 58 are connected to the input/output I/F 54.

The computer 56 includes a processor 60, a storage 62, and a RAM 64. The processor 60 controls an entire imaging apparatus 10. The processor 60 is, for example, an arithmetic processing apparatus including a CPU and a GPU, and the GPU is operated under the control of the CPU and is responsible for executing processing related to an image. Here, the arithmetic processing apparatus including the CPU and the GPU is described as an example of the processor 60, but this is merely an example, and the processor 60 may be one or more CPUs into which a GPU function is integrated, or may be one or more CPUs into which a GPU function is not integrated.

The processor 60, the storage 62, and the RAM 64 are connected via a bus 66, and the bus 66 is connected to the input/output I/F 54. The storage 62 is a non-transitory storage medium and stores various parameters and various programs. The storage 62 is, for example, a flash memory (for example, EEPROM). It should be noted that this is merely an example, and an HDD or the like may be applied as the storage 62 together with the flash memory. The RAM 64 transitorily stores various information and is used as a work memory. Examples of the RAM 64 include a DRAM and/or an SRAM.

The processor 60 reads out a necessary program from the storage 62 and executes the readout program on the RAM 64. The processor 60 controls the control driver 52 and the signal processing circuit 36 in accordance with the program executed on the RAM 64. The control driver 52 controls the photoelectric conversion element 34 under control of a processor 94.

The communication device 58 is connected to the processor 60 via the input/output I/F 54 and the bus 66. The communication device 58 is communicably connected to the processing apparatus 90 by wire or wirelessly. The communication device 58 controls the exchange of information with the processing apparatus 90. For example, the communication device 58 transmits the data in response to a request from the processor 60 to the processing apparatus 90. Further, the communication device 58 receives the data transmitted from the processing apparatus 90 and outputs the received data to the processor 60 via the bus 66.

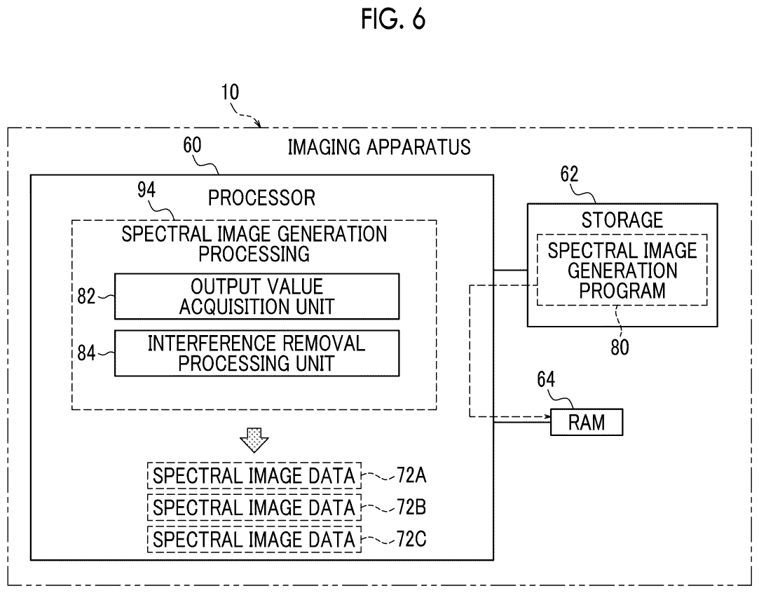

For example, as shown in FIG. 6, the storage 62 stores a spectral image generation program 80. The processor 60 reads out the spectral image generation program 80 from the storage 62 and executes the readout spectral image generation program 80 on the RAM 64. The processor 60 executes spectral image generation processing for generating a plurality of spectral image data 72 in accordance with the spectral image generation program 80 executed on the RAM 64. The spectral image generation processing is realized by the processor 60 operating as an output value acquisition unit 82 and an interference removal processing unit 84 in accordance with the spectral image generation program 80.

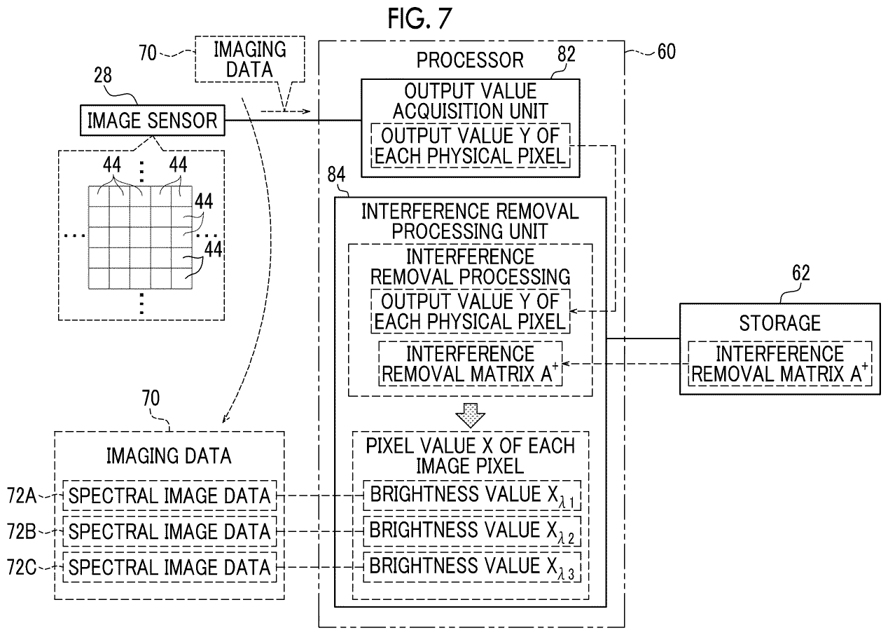

As an example, as shown in FIG. 7, in a case in which the imaging data 70 output from the image sensor 28 is input to the processor 60, the output value acquisition unit 82 acquires an output value Y of each physical pixel 44 based on the imaging data 70. The output value Y of each physical pixel 44 corresponds to a brightness value of each image pixel included in the imaging data 70.

Here, the output value Y of each physical pixel 44 is a value including interference (that is, crosstalk). That is, since the light in each wavelength range λ of the first wavelength range M, the second wavelength range λ₂, and the third wavelength range λ₃ is incident on each physical pixel 44, the output value Y is a value in which a value corresponding to a light amount of the first wavelength range λ₁, a value corresponding to a light amount of the second wavelength range λ₂, and a value corresponding to a light amount of the third wavelength range λ₃ are mixed.

In order to obtain the spectral image data 72, the processor 60 needs to perform interference removal processing, which is processing of separating and extracting the value corresponding to each wavelength range λ from the output value Y, that is, processing of removing interference, on the output value Y for each physical pixel 44. Therefore, in the first embodiment, in order to acquire the spectral image data 72, the interference removal processing unit 84 executes the interference removal processing on the output value Y of each physical pixel 44 acquired by the output value acquisition unit 82.

Here, the interference removal processing will be described. The output value Y of each physical pixel 44 includes each brightness value for each polarization angle β as a component of the output value Y for red, green, and blue. The output value Y of each physical pixel 44 is represented by Expression (1).

$$Y = ( \begin{matrix}{Y}_{β1\_ R} \\ {Y}_{β2\_ R} \\ {Y}_{β3\_ R} \\ {Y}_{β4\_ R} \\ {Y}_{β1\_ G} \\ {Y}_{β2\_ G} \\ {Y}_{β3\_ G} \\ {Y}_{β4\_ G} \\ {Y}_{β1\_ B} \\ {Y}_{β2\_ B} \\ {Y}_{β3\_ B} \\ {Y}_{β4\_ B}\end{matrix} ) \qquad ( 1 )$$

Y_{β1_R} is a brightness value of the component of the output value Y having the polarization angle of the first polarization angle β₁ in red, Y_{β2_R} is a brightness value of the component of the output value Y having the polarization angle of the second polarization angle β₂ in red, Y_{β3_R} is a brightness value of the component of the output value Y having the polarization angle of the third polarization angle β₃ in red, and Y_{β4_R} is a brightness value of the component of the output value Y having the polarization angle of the fourth polarization angle β₄ in red.

In addition, Y_{β1_G} is a brightness value of the component of the output value Y having the polarization angle of the first polarization angle β₁ in green, Y_{β2_G} is a brightness value of the component of the output value Y having the polarization angle of the second polarization angle β₂ in green, Y_{β3_G} is a brightness value of the component of the output value Y having the polarization angle of the third polarization angle β₃ in green, and Y_{β4_G} is a brightness value of the component of the output value Y having the polarization angle of the fourth polarization angle β₄ in green.

In addition, Y_{β1_B} is a brightness value of the component of the output value Y having the polarization angle of the first polarization angle β₁ in blue, Y_{β2_B} is a brightness value of the component of the output value Y having the polarization angle of the second polarization angle β₂ in blue, Y_{β3_B} is a brightness value of the component of the output value Y having the polarization angle of the third polarization angle β₃ in blue, and Y_{β4_B} is a brightness value of the component of the output value Y having the polarization angle of the fourth polarization angle β₄ in blue.

A pixel value X of each image pixel forming the spectral image data 72 includes, as components of the pixel value X, a brightness value X_{λ1} of polarized light having the first wavelength range λ₁ and the first polarization angle α₁ (hereinafter, referred to as “first wavelength range polarized light”), a brightness value X_{λ2} of polarized light having the second wavelength range λ₂ and the second polarization angle α₂ (hereinafter, referred to as “second wavelength range polarized light”), and a brightness value X_{λ3} of polarized light having the third wavelength range λ₃ and the third polarization angle α₃ (hereinafter, referred to as “third wavelength range polarized light”). The pixel value X of each image pixel is represented by Expression (2).

$$X = ( \begin{matrix}{X}_{λ 1} \\ {X}_{λ 2} \\ {X}_{λ 3}\end{matrix} ) \qquad ( 2 )$$

The output value Y of each physical pixel 44 is represented by Expression (3).

Y=A×X (3)

In Expression (3), A is an interference matrix. The interference matrix A (not shown) is a matrix indicating the characteristics of the interference. The interference matrix A is defined in advance based on a plurality of known values, such as the spectrum of the incident light, the spectral transmittance of the first lens 30, the spectral transmittance of the second lens 32, the spectral transmittance of the plurality of spectral filters 20, and the spectral sensitivity of the image sensor 28.

In a case in which an interference removal matrix which is the general inverse matrix of the interference matrix A is denoted by A⁺, the pixel value X of each image pixel is represented by Expression (4).

X=A⁺×Y (4)

Similar to the interference matrix A, the interference removal matrix A⁺ is also a matrix defined based on the spectrum of the incident light, the spectral transmittance of the first lens 30, the spectral transmittance of the second lens 32, the spectral transmittance of the plurality of spectral filters 20, and the spectral sensitivity of the image sensor 28. The interference removal matrix A is stored in the storage 62 in advance.

The interference removal processing unit 84 acquires the interference removal matrix A⁺ stored in the storage 62 and the output value Y of each physical pixel 44 acquired by the output value acquisition unit 82, and outputs the pixel value X of each image pixel by Expression (4) based on the interference removal matrix A⁺ and the output value Y of each physical pixel 44, which are acquired.

Here, as described above, the pixel value X of each image pixel includes, as components of the pixel value X, the brightness value Xu of the first wavelength range polarized light, the brightness value X_{λ2} of the second wavelength range polarized light, and the brightness value X_{λ3} of the third wavelength range polarized light.

The spectral image data 72A in the imaging data 70 is an image corresponding to the brightness value X_{λ1} of light in the first wavelength range λ₁ (that is, an image depending on the brightness value X_{λ1}). The spectral image data 72B in the imaging data 70 is an image corresponding to the brightness value X_{λ2} of light in the second wavelength range λ₂ (that is, an image depending on the brightness value X_{λ2}). The spectral image data 72C in the imaging data 70 is an image corresponding to the brightness value X_{λ3} of light in the third wavelength range λ₃ (that is, an image depending on the brightness value X_{λ3}).

As described above, in a case in which the interference removal processing unit 84 executes the interference removal processing, the imaging data 70 is separated into the spectral image data 72A corresponding to the brightness value X_{λ1} of the first wavelength range polarized light, the spectral image data 72B corresponding to the brightness value X_{λ2} of the second wavelength range polarized light, and the spectral image data 72C corresponding to the brightness value X_{λ3} of the third wavelength range polarized light. That is, the imaging data 70 is separated into the spectral image data 72 for each wavelength range λ of the plurality of spectral filters 20.

Hereinafter, the processing apparatus 90 according to the first embodiment will be described.

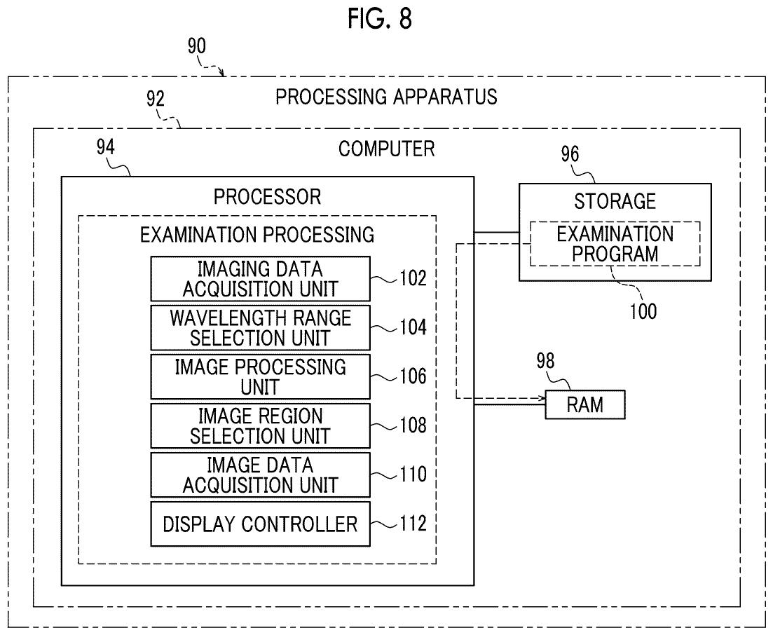

As shown in FIG. 8 as an example, the processing apparatus 90 comprises a computer 92. The computer 92 comprises the processor 94, a storage 96, and a RAM 98. The processor 94, the storage 96, and the RAM 98 are realized by the same hardware as the processor 60, the storage 62, and the RAM 64 (see FIG. 4) as described above. The processor 94 is an example of a “processor” according to the technique of the present disclosure.

An examination program 100 is stored in the storage 96. The processor 94 reads out the examination program 100 from the storage 96 and executes the readout examination program 100 on the RAM 98. The processor 94 executes examination processing in accordance with the examination program 100 executed on the RAM 98. The examination processing is realized by the processor 94 operating as an imaging data acquisition unit 102, a wavelength range selection unit 104, an image processing unit 106, an image region selection unit 108, an image data acquisition unit 110, and a display controller 112 in accordance with the examination program 100. The examination on the subject 200 is executed by the examination processing. The examination may be any examination. For example, the examination includes an examination of discriminating the goodness or badness of the subject 200. Hereinafter, the examination processing will be described with an example of a case in which the examination of discriminating the goodness or badness of the subject 200 is performed.

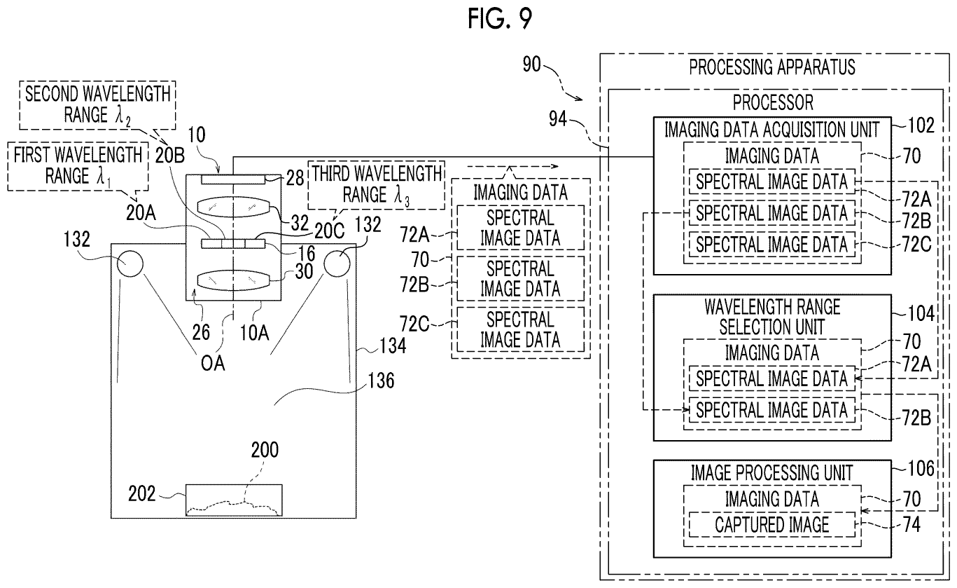

As an example, as shown in FIG. 9, the subject 200 is irradiated with the light from the plurality of light sources 132. The imaging apparatus 10 images the subject 200 in a state in which the subject 200 is irradiated with the light from the plurality of light sources 132. The imaging apparatus 10 transmits the imaging data 70 obtained by imaging the subject 200 to the processing apparatus 90. The imaging data 70 is image data including the plurality of spectral image data 72. The imaging data is an example of “second imaging data” according to the technique of the present disclosure.

The imaging data acquisition unit 102 acquires the imaging data 70 received by the processing apparatus 90. The wavelength range selection unit 104 selects two spectral image data 72 from among the plurality of spectral image data 72 included in the imaging data 70 acquired by the imaging data acquisition unit 102. In the example shown in FIG. 9, the spectral image data 72A corresponding to the light in the first wavelength range λ and the spectral image data 72B corresponding to the light in the second wavelength range λ₂ are selected as the two spectral image data 72. The two wavelength ranges λ corresponding to the two spectral image data 72 are examples of a “plurality of wavelength ranges” according to the technique of the present disclosure.

The two wavelength ranges λ may be selected, for example, based on a wavelength range selection instruction from a user or the like received by the reception device 124 (see FIG. 1), or may be selected based on a result of executing image analysis processing on the plurality of spectral image data 72. In addition, in the example shown in FIG. 9, the two wavelength ranges 2 are selected from among the three wavelength ranges λ corresponding to the three spectral filters 20 of the pupil split filter 16, but in a case in which the pupil split filter 16 includes four or more spectral filters 20, the two wavelength ranges λ may be selected from among the four or more wavelength ranges 2.

In addition, the two wavelength ranges λ may be selected from among, for example, two or more types of predetermined combinations, or may be selected based on an attribute of the subject 200 (for example, a type of the subject). In addition, the two wavelength ranges λ may be selected based on an imaging condition of the subject 200 (for example, a lighting condition by the plurality of light sources 132). The lighting condition may include the wavelength ranges λ of the light applied from the plurality of light sources 132 and/or the output of the light.

For example, in a case in which the subject 200 is the plant, the two wavelength ranges λ may be selected from among a first combination of a near-infrared wavelength range having a central wavelength of 850 nm and a red wavelength range having a central wavelength of 650 nm, and a second combination of a red wavelength range having a central wavelength of 717 nm and a green wavelength range having a central wavelength of 560 nm.

The image processing unit 106 acquires the imaging data 70 including the spectral image data 72 corresponding to the light in the two wavelength ranges λ selected by the wavelength range selection unit 104, and executes the image processing on a captured image 74 indicated by the imaging data 70. The image processing may include processing related to noise included in the captured image 74. The processing related to the noise may include edge enhancement processing and/or noise reduction processing. In addition, the image processing unit 106 may execute arithmetic processing on the captured image 74. The arithmetic processing may include processing related to visibility of the captured image 74. The processing related to the visibility may include gradation processing and/or gamma-correction processing. It should be noted that processing of correcting the lighting distribution of the lighting, the spectral intensity of the lighting, the reduction in the peripheral light amount of the imaging apparatus 10, and/or the distortion of the image may be performed on the spectral image data 72 before and after the processing related to the noise.

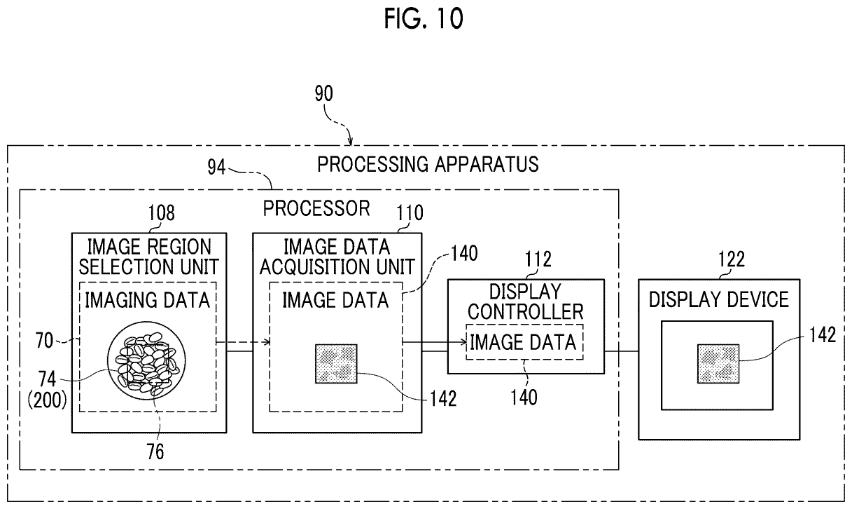

It should be noted that the image processing unit 106 may execute the image processing on a contrast map 142 (see FIG. 10) indicated by image data 140 described below, instead of executing the image processing on the captured image 74 indicated by the imaging data 70. In addition, the image processing unit 106 may execute the arithmetic processing on the contrast map 142 indicated by the image data 140 described below, instead of executing the arithmetic processing on the captured image 74 indicated by the imaging data 70.

As an example, as shown in FIG. 10, the subject 200 is included as an image in the captured image 74. The subject 200 is represented by colors corresponding to the two wavelength ranges λ selected by the wavelength range selection unit 104.

The image region selection unit 108 selects an image region 76 from the captured image 74. The image region 76 may be selected based on, for example, an image region selection instruction from the user or the like received by the reception device 124 (see FIG. 1), or may be selected based on a result of executing the image analysis processing on the captured image 74. The image region 76 is selected from a region inside an outer edge of the subject 200 included as an image in the captured image 74. In the example shown in FIG. 10, a quadrangular region is selected as the image region 76, but the shape of the image region 76 may be optional. The image region 76 may be selected by freehand. The image region 76 is an image region corresponding to a selected region of the subject 200.

The image data acquisition unit 110 acquires the image data 140 indicating the contrast map 142 from the imaging data 70 in which the image region 76 is selected by the image region selection unit 108. Specifically, the image data acquisition unit 110 derives a contrast C of the brightness of the light in the two wavelength ranges 2 by Expression (5) for each image pixel included in the image region 76, and generates the contrast map 142 that is an image in which the contrast C of each image pixel is represented by a heat map. L1 indicates the brightness of the light in one wavelength range λ of the two wavelength ranges λ in each image pixel, and L2 indicates the brightness of the light in the other wavelength range λ of the two wavelength ranges λ in each image pixel.

C=(L1−L2)÷(L1+L2) (5)

It should be noted that Expression (5) is an expression of the Michelson contrast, and is derived from Expression (6).

C=((L1−L2)/2)+((L1+L2)/2) (6)

In addition, in a case in which the subject 200 is the plant and the near-infrared wavelength range and the red wavelength range are selected as the two wavelength ranges λ, the normalized difference vegetation index NDVI may be derived by Expression (7) as the contrast C. Then, an NDVI map which is an image indicating the normalized difference vegetation index NDVI of each image pixel may be generated as the contrast map 142. NIR indicates the brightness of the light in the near-infrared wavelength range in each image pixel, and Red indicates the brightness of the light in the red wavelength range in each image pixel.

NDVI=(NIR−Red)÷(NIR+Red) (7)

In addition, here, although an example of deriving the contrast C is described, an indicator related to the discrimination of the goodness or badness of the subject 200 may be derived by using an expression other than Expression (5). In addition, the indicator may be an indicator related to discrimination other than the discrimination of the goodness or badness of the subject 200. In addition, the indicator may be an indicator based on the brightness of the light in the two wavelength ranges 2, in addition to the contrast C. In addition, the contrast map 142 may be represented by an isoline diagram or the like, in addition to the heat map. In addition, as an example of the indicator, the “brightness of the light in the wavelength range λ” and/or the “sum of the brightness of the light in the plurality of wavelength ranges λ” may be used.

The contrast C corresponding to each image pixel included in the contrast map 142 is an example of an “indicator” and a “contrast” according to the technique of the present disclosure. The normalized difference vegetation index NDVI corresponding to each image pixel included in the NDVI map is an example of a “normalized difference vegetation index” according to the technique of the present disclosure.

The display controller 112 acquires the image data 140 acquired by the image data acquisition unit 110. The display controller 112 performs control of displaying the image data 140 on the display device 122. Therefore, the contrast map 142 indicated by the image data 140 is displayed on the display device 122.

In this way, with the processing apparatus 90, the contrast map 142 can be displayed on the display device 122. Therefore, it is possible to discriminate, by the visual observation, the goodness or badness of the subject 200 based on the contrast map 142.

Meanwhile, a display range of the contrast map 142 suitable for visual observation may be changed depending on the imaging conditions of the subject 200 and/or the lighting. Therefore, there is a possibility that the display range is not suitable for the visual observation depending on the imaging conditions.

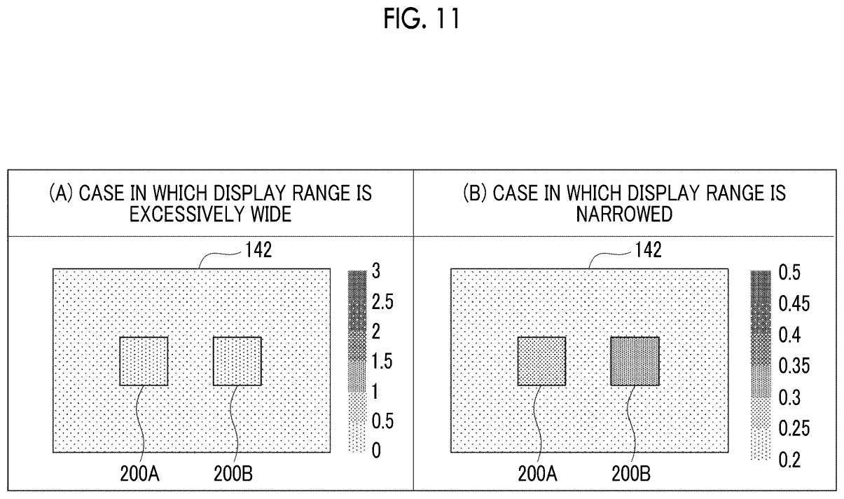

Here, FIG. 11 shows a first example in which the display range is made different for the contrast map 142 including a first subject 200A and a second subject 200B. In FIG. 11, shading of the contrast map 142 represents a magnitude of the contrast C. As an example, the second subject 200B is a subject having a larger contrast C than the first subject 200A. The larger contrast C here means, for example, that a representative value (that is, an average value, a maximum value, a median value, or the like) of the contrast C is large. For example, the first subject 200A is a subject assuming a plurality of bad seeds, and the second subject 200B is a subject assuming a plurality of good seeds.

(A) of FIG. 11 shows an example of a case in which the display range is wider than the display range suitable for the visual observation, that is, a case in which the display range is excessively wide. In contrast, (B) of FIG. 11 shows an example of a case in which the display range is set to a display range suitable for the visual observation by narrowing the display range with respect to the display range shown in (A) of FIG. 11. The display range suitable for the visual observation is decided by the identification ability of the user who is an observer.

As shown in (A) of FIG. 11, in a case in which the display range is excessively wide, the noise included in the contrast map 142 is not conspicuous, but it is difficult to check, by the visual observation, a difference between the first subject 200A and the second subject 200B. In contrast, as shown in (B) of FIG. 11, in a case in which the display range is narrowed, the noise is increased, but it is possible to check, by the visual observation, the difference between the first subject 200A and the second subject 200B.

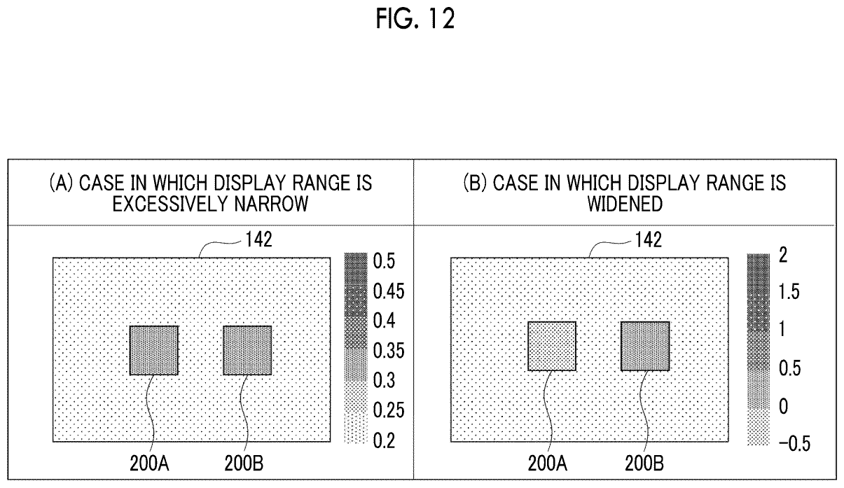

FIG. 12 shows a second example in which the display range is made different for the contrast map 142 including a first subject 200A and a second subject 200B. The second example shown in FIG. 12 is an example in which an amount of the noise included in the contrast map 142 is larger than the amount of the noise in the first example shown in FIG. 11.

(A) of FIG. 12 shows an example of a case in which the display range is narrower than the display range suitable for the visual observation, that is, a case in which the display range is excessively narrow. In contrast, (B) of FIG. 12 shows an example of a case in which the display range is set to the display range suitable for the visual observation by widening the display range with respect to the display range shown in (A) of FIG. 12.

As shown in (A) of FIG. 12, in a case in which the display range is excessively narrow, the noise included in the contrast map 142 is conspicuous, and it is difficult to check, by the visual observation, the difference between the first subject 200A and the second subject 200B. In contrast, as shown in (A) of FIG. 12, in a case in which the display range is widened, the contrast C is slightly higher in the second subject 200B than in the first subject 200A, and thus it is possible to check, by the visual observation, the difference between the first subject 200A and the second subject 200B.

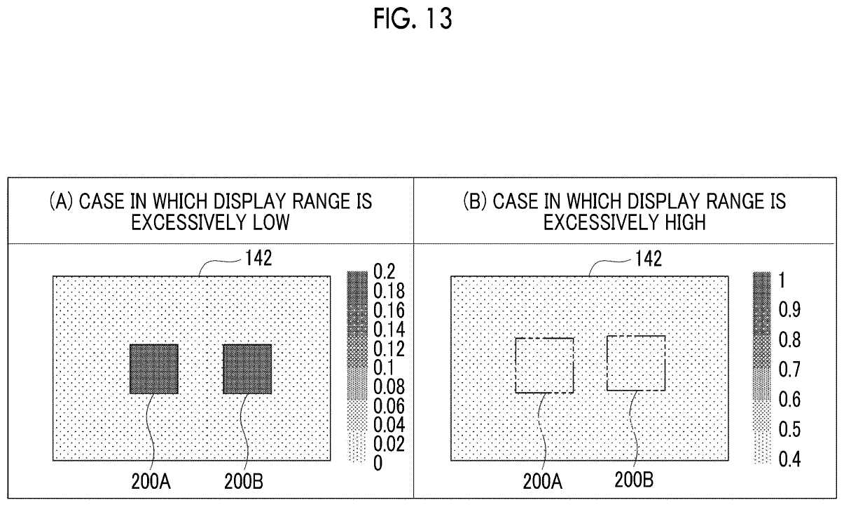

FIG. 13 shows a third example in a case in which the display range is made different for the contrast map 142 including the first subject 200A and the second subject 200B. A third example shown in FIG. 13 is an example in which the amount of the noise included in the contrast map 142 is the same as the amount of the noise in the first example shown in FIG. 11.

(A) of FIG. 13 shows an example of a case in which the display range is lower than the display range suitable for the visual observation, that is, a case in which the display range is excessively low. In contrast, (B) of FIG. 13 shows an example of a case in which the display range is higher than the display range suitable for the visual observation, that is, a case in which the display range is excessively high.

As shown in (A) of FIG. 13, in a case in which the display range is excessively low, it is difficult to check, by the visual observation, the difference between the first subject 200A and the second subject 200B. Similarly, as shown in (B) of FIG. 13, in a case in which the display range is excessively high, it is difficult to check, by the visual observation, the difference between the first subject 200A and the second subject 200B.

In a case in which the display range is not appropriate in a case of displaying the contrast map 142, it is difficult to check, by the visual observation, the difference between the first subject 200A and the second subject 200B. Therefore, in the processing apparatus 90, in a case in which the examination processing is executed, display range decision processing described below is executed to decide the display range suitable for the visual observation as the display range used in the examination processing.

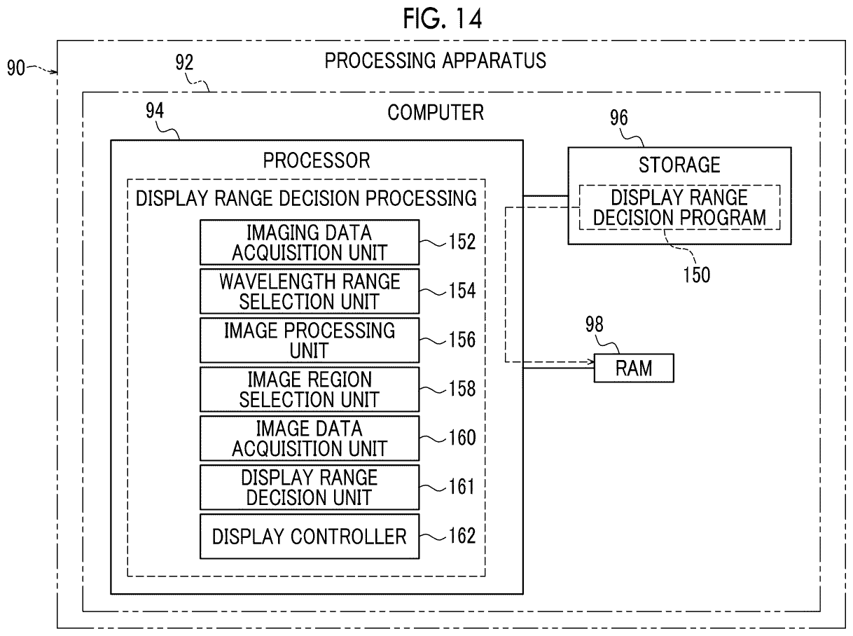

As an example, as shown in FIG. 14, a display range decision program 150 is stored in the storage 96 of the processing apparatus 90. The display range decision program 150 is an example of a “program” according to the technique of the present disclosure. The processor 94 reads out the display range decision program 150 from the storage 96 and executes the readout display range decision program 150 on the RAM 98. The processor 94 executes display range decision processing for deciding the display range in accordance with the display range decision program 150 executed on the RAM 98. The display range is an example of a “display condition” according to the technique of the present disclosure. The display range decision processing is realized by the processor 94 operating as an imaging data acquisition unit 152, a wavelength range selection unit 154, an image processing unit 156, an image region selection unit 158, an image data acquisition unit 160, a display range decision unit 161, and a display controller 162 in accordance with the display range decision program 150.

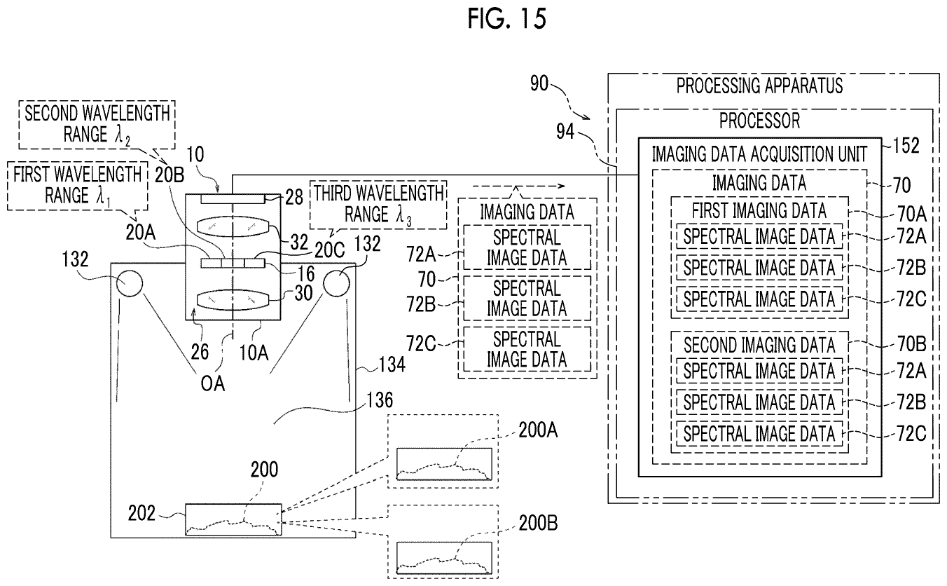

As an example, as shown in FIG. 15, in the display range decision processing, the first subject 200A and the second subject 200B are used as the subject 200. The first subject 200A and the second subject 200B are subjects of the same type. The second subject 200B is a subject having a larger contrast C than the first subject 200A. The larger contrast C here means, for example, that a representative value (that is, an average value, a maximum value, a median value, or the like) of the contrast C is large.

For example, the first subject 200A is the plurality of bad seeds, and the second subject 200B is the plurality of good seeds. The first subject 200A is an example of a “first subject” according to the technique of the present disclosure, and the second subject 200B is an example of a “second subject” according to the technique of the present disclosure. The first subject 200A and the second subject 200B are sequentially imaged by the imaging apparatus 10 under the same imaging condition in a state in which the plurality of light sources 132 apply the light.

In a case in which the first subject 200A is imaged, the imaging data acquisition unit 152 acquires first imaging data 70A, which is the imaging data transmitted from the imaging apparatus 10 and received by the processing apparatus 90. In addition, in a case in which the second subject 200B is imaged, the imaging data acquisition unit 152 acquires second imaging data 70B, which is the imaging data transmitted from the imaging apparatus 10 and received by the processing apparatus 90. As a result, the imaging data acquisition unit 152 acquires the imaging data including the first subject 200A and the second subject 200B imaged by the imaging apparatus 10, that is, the imaging data 70 including the first imaging data 70A corresponding to the first subject 200A and the second imaging data 70B corresponding to the second subject 200B. The imaging data 70 including the first subject 200A and the second subject 200B is an example of “first imaging data” according to the technique of the present disclosure.

It should be noted that the first subject 200A and the second subject 200B may be imaged together in addition to separate imaging. Then, the imaging data 70 including the first imaging data 70A corresponding to the first subject 200A and the second imaging data 70B corresponding to the second subject 200B may be acquired by the imaging data acquisition unit 152.

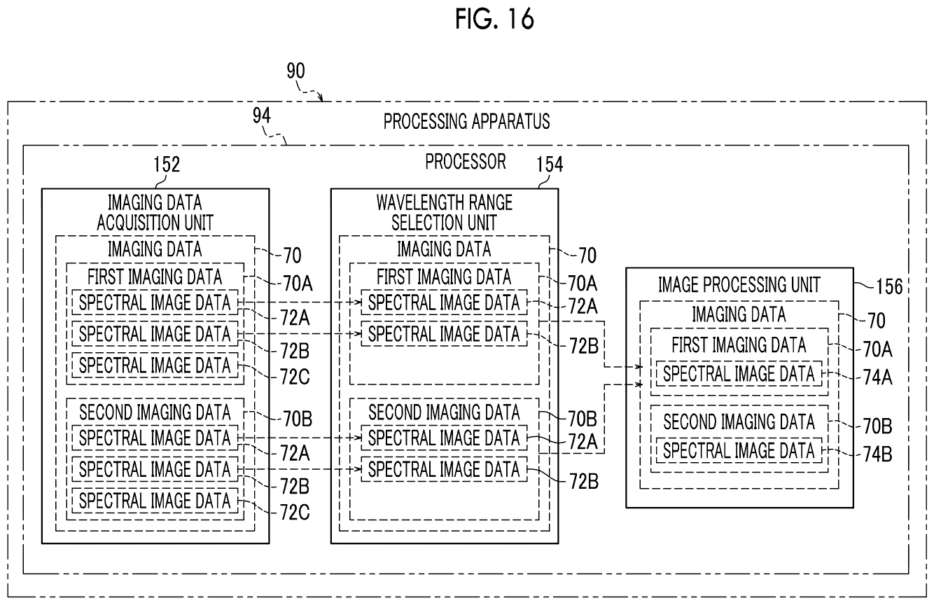

As an example, as shown in FIG. 16, the wavelength range selection unit 154 selects the two spectral image data 72 from among the plurality of spectral image data 72 included in the imaging data 70 acquired by the imaging data acquisition unit 152, in the same manner as the wavelength range selection unit 104. That is, the wavelength range selection unit 154 selects the two spectral image data 72 from among the plurality of spectral image data 72 included in the first imaging data 70A, and selects the two spectral image data 72 from among the plurality of spectral image data 72 included in the second imaging data 70B. In this case, the wavelength range selection unit 154 selects the spectral image data 72 corresponding to the same two wavelength ranges λ from the first imaging data 70A and the second imaging data 70B, respectively. In addition, the wavelength range selection unit 154 selects the two wavelength ranges λ that are the same as the two wavelength ranges λ selected in the examination processing.

In the example shown in FIG. 16, the spectral image data 72A corresponding to the light in the first wavelength range λ₁ and the spectral image data 72B corresponding to the light in the second wavelength range λ₂ are selected as the two spectral image data 72.

The image processing unit 156 acquires the imaging data 70 including the first imaging data 70A and the second imaging data 70B in which the two wavelength ranges λ are selected by the wavelength range selection unit 154, and executes the image processing on a first captured image 74A indicated by the first imaging data 70A and a second captured image 74B indicated by the second imaging data 70B. The image processing in this case is the same as the image processing executed by the image processing unit 106. In addition, the image processing unit 156 may execute the arithmetic processing on the first captured image 74A and the second captured image 74B. The arithmetic processing in this case is the same as the arithmetic processing executed by the image processing unit 106. The image processing is an example of “image processing” according to the technique of the present disclosure. The arithmetic processing is an example of “arithmetic processing” according to the technique of the present disclosure.

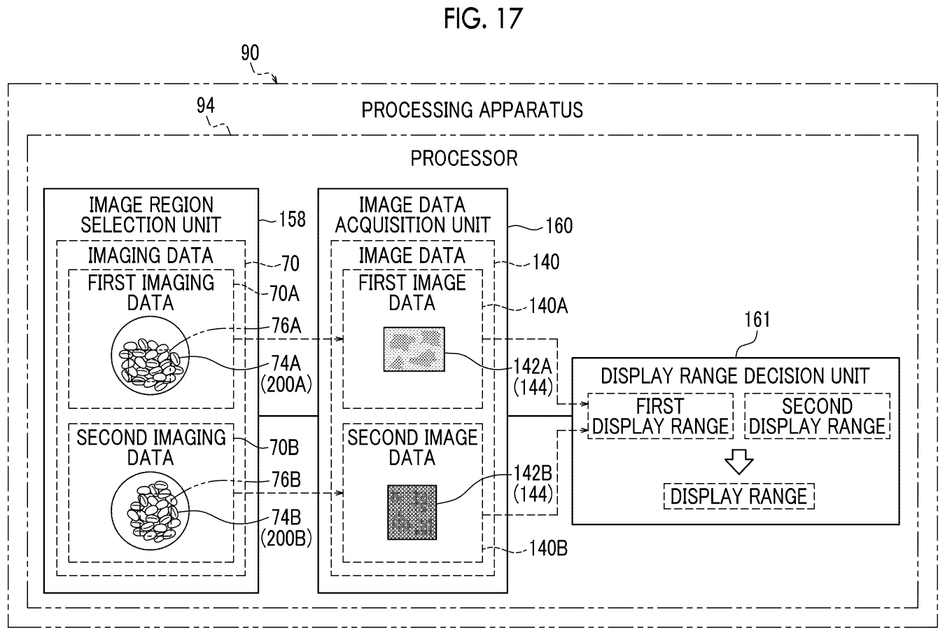

It should be noted that the image processing unit 156 may execute the image processing on a first contrast map 142A and a second contrast map 142B (see FIG. 17) that are indicated by the image data 140 and described below, instead of executing the image processing on the first captured image 74A and the second captured image 74B indicated by the imaging data 70. In addition, the image processing unit 156 may execute the arithmetic processing on the first contrast map 142A and the second contrast map 142B that are indicated by the image data 140 and described below, instead of executing the arithmetic processing on the first captured image 74A and the second captured image 74B indicated by the imaging data 70.

As an example, as shown in FIG. 17, the first subject 200A is included as an image in the first captured image 74A, and the second subject 200B is included as an image in the second captured image 74B. The first subject 200A and the second subject 200B are represented, respectively, by colors corresponding to the two wavelength ranges λ selected by the wavelength range selection unit 154.

The image region selection unit 158 selects a first image region 76A from the first captured image 74A. Similarly, the image region selection unit 158 selects a second image region 76B from the second captured image 74B. The sizes and/or the shapes of the first image region 76A and the second image region 76B may be the same as or different from each other. The first image region 76A and the second image region 76B may be selected based on, for example, an image region selection instruction from the user or the like received by the reception device 124 (see FIG. 1), or may be selected based on a result of executing the image analysis processing on the first captured image 74A and the second captured image 74B.

The first image region 76A is selected from a region inside an outer edge of the first subject 200A included as an image in the first captured image 74A. Similarly, the second image region 76B is selected from a region inside an outer edge of the second subject 200B included as an image in the second captured image 74B. In the example shown in FIG. 17, a quadrangular region is selected as the first image region 76A, but the shape of the first image region 76A may be optional. Similarly, in the example shown in FIG. 17, a quadrangular region is selected as the second image region 76B, but the shape of the second image region 76B may be optional. The first image region 76A and the second image region 76B may be selected by freehand. The first image region 76A is an image region corresponding to a selected region of the first subject 200A, and the second image region 76B is an image region corresponding to a selected region of the second subject 200B.

The image data acquisition unit 160 acquires first image data 140A indicating the first contrast map 142A from the first imaging data 70A in which the first image region 76A is selected by the image region selection unit 158, in the same manner as in the image data acquisition unit 110. Further, the image data acquisition unit 160 acquires second image data 140B indicating the second contrast map 142B from the second imaging data 70B in which the second image region 76B is selected by the image region selection unit 158, in the same manner as in the image data acquisition unit 110.

Specifically, the image data acquisition unit 160 derives the contrast C of the brightness of the light in the two wavelength ranges λ for each image pixel included in the first image region 76A by Expression (5), and generates the first contrast map 142A which is an image in which the contrast C of each image pixel is represented by a heat map. In addition, the image data acquisition unit 160 derives the contrast C of the brightness of the light in the two wavelength ranges λ for each image pixel included in the second image region 76B by Expression (5), and generates the second contrast map 142B which is an image in which the contrast C of each image pixel is represented by a heat map. As a result, a contrast map image 144 including the first contrast map 142A and the second contrast map 142B is obtained. The contrast map image 144 is an image on which the image processing and/or the arithmetic processing described above is executed. In the following description, the description will be made on the premise that the noise remains in the contrast map image 144.

The image data 140 including the first image data 140A and the second image data 140B is an example of “first image data” according to the technique of the present disclosure. The contrast map image 144 is an example of an “image indicated by the first image data” according to the technique of the present disclosure. The contrast C corresponding to each image pixel included in the first contrast map 142A is an example of a “first indicator” according to the technique of the present disclosure, and the contrast C corresponding to each image pixel included in the second contrast map 142B is an example of a “second indicator” according to the technique of the present disclosure.

The display range decision unit 161 decides the display range as described below based on the first image data 140A and the second image data 140B. First, the display range decision unit 161 derives the representative value (hereinafter, referred to as “first contrast representative value Ca”) of the contrast C included in the first contrast map 142A. In addition, the display range decision unit 161 derives the representative value (hereinafter, referred to as “second contrast representative value Cb”) of the contrast C included in the second contrast map 142B. The representative value may be any one of an average value, a maximum value, or a median value of the contrast C.

Subsequently, the display range decision unit 161 derives a difference (hereinafter, also simply referred to as “difference”) between the first contrast representative value Ca and the second contrast representative value Cb. The difference between the first contrast representative value Ca and the second contrast representative value Cb indicates a relationship between the first subject 200A and the second subject 200B in the contrast map image 144 in a state in which the noise is included. It should be noted that, as described above, since the image processing and/or the arithmetic processing is executed on the imaging data 70 and/or the image data 140, the difference between the first contrast representative value Ca and the second contrast representative value Cb is a difference in a state in which the image processing and/or the arithmetic processing is executed on the contrast map image 144. The difference is an example of a “relationship between the first subject and the second subject”, a “relationship of the indicator between the first subject and the second subject”, and a “degree of difference between the first indicator and the second indicator” according to the technique of the present disclosure. Then, the display range decision unit 161 decides the display range by selecting one of a first display range or a second display range based on the difference.

Specifically, in a case in which the difference is larger than a predetermined threshold value D, the display range decision unit 161 selects the first display range from among the first display range and the second display range. On the other hand, in a case in which the difference is equal to or smaller than the threshold value D, the display range decision unit 161 selects the second display range from among the first display range and the second display range. As described above, the display range is selected from among the first display range and the second display range based on the magnitude of the difference between the first contrast representative value Ca and the second contrast representative value Cb. The first display range and the second display range are examples of a “plurality of display ranges” according to the technique of the present disclosure.

The threshold value D for selecting the display range may be optionally decided, for example, based on the amount of the noise included in the first contrast map 142A and the second contrast map 142B obtained in advance. For example, the threshold value D may be larger as the amount of the noise is larger, and the threshold value D may be is smaller as the amount of the noise is smaller. The threshold value D may be set to, for example, 0.06. The threshold value D is an example of a “threshold value” according to the technique of the present disclosure.

In a case in which the first display range is selected, the display range decision unit 161 decides an upper limit value MAX of the first display range by Expression (8), and decides a lower limit value MIN of the first display range by Expression (9). Here, C1 is a larger value out of the first contrast representative value Ca and the second contrast representative value Cb, and B1 is a first correction value. In addition, C2 is a smaller value out of the first contrast representative value Ca and the second contrast representative value Cb, and B2 is a second correction value.

MAX=C1+B1 (8)

MIN=C2+B2 (9)

In such a manner, in a case in which the difference is larger than the threshold value D, the upper limit value MAX of the display range is decided based on the larger value out of the first contrast representative value Ca and the second contrast representative value Cb, and the lower limit value MIN of the display range is decided based on the smaller value out of the first contrast representative value Ca and the second contrast representative value Cb.

It should be noted that the first correction value B1 and the second correction value B2 may be optionally decided based on the amount of the noise included in the first contrast map 142A and the second contrast map 142B obtained in advance. For example, the first correction value B1 and the second correction value B2 may be larger as the amount of the noise is larger, and the first correction value B1 and the second correction value B2 may be smaller as the amount of the noise is smaller. The first correction value B1 and the second correction value B2 may be set to, for example, 0.03. The first correction value B1 and the second correction value B2 may be values that are the same as or different from each other. The first correction value B1 is an example of a “first correction value” according to the technique of the present disclosure, and the second correction value B2 is an example of a “second correction value” according to the technique of the present disclosure.

On the other hand, in a case in which the second display range is selected, the display range decision unit 161 decides, as the threshold value D, a difference between the upper limit value MAX and the lower limit value MIN of the second display range, decides the upper limit value MAX of the second display range by Expression (10), and decides the lower limit value MIN of the second display range by Expression (11). Here, (Ca+Cb)/2 is an average value of the first contrast representative value Ca and the second contrast representative value Cb, B3 is a third correction value, and B4 is a fourth correction value.

MAX(Ca+Cb)÷2+B3 (10)

MIN=(Ca+Cb)÷2−B4 (11)

In this way, in a case in which the difference is equal to or smaller than the threshold value D, the upper limit value MAX and the lower limit value MIN of the display range are decided based on the average value of the first contrast representative value Ca and the second contrast representative value Cb. In addition, the upper limit value MAX of the display range is decided based on the average value and the third correction value, and the lower limit value MIN of the display range is decided based on the average value and the fourth correction value.

It should be noted that the third correction value B3 and the fourth correction value B4 may be optionally decided based on the amount of the noise included in the first contrast map 142A and the second contrast map 142B obtained in advance. For example, the third correction value B3 and the fourth correction value B4 may be larger as the amount of the noise is larger, and the third correction value B3 and the fourth correction value B4 may be smaller as the amount of the noise is smaller. The third correction value B3 and the fourth correction value B4 may be set to, for example, 0.03. The third correction value B3 and the fourth correction value B4 may be values that are the same as or different from each other. The first correction value B1, the second correction value B2, the third correction value B3, and the fourth correction value B4 may be any combination of values. The third correction value B3 is an example of a “third correction value” according to the technique of the present disclosure, and the fourth correction value B4 is an example of a “fourth correction value” according to the technique of the present disclosure.

As described above, the display range is decided by selecting one of the first display range or the second display range based on a relationship between the difference and the threshold value D. It should be noted that, here, an example is described in which the display range is selected from among the first display range and the second display range, the display range may be selected from among three or more display ranges. The display range is decided as described above based on the first image data 140A and the second image data 140B.

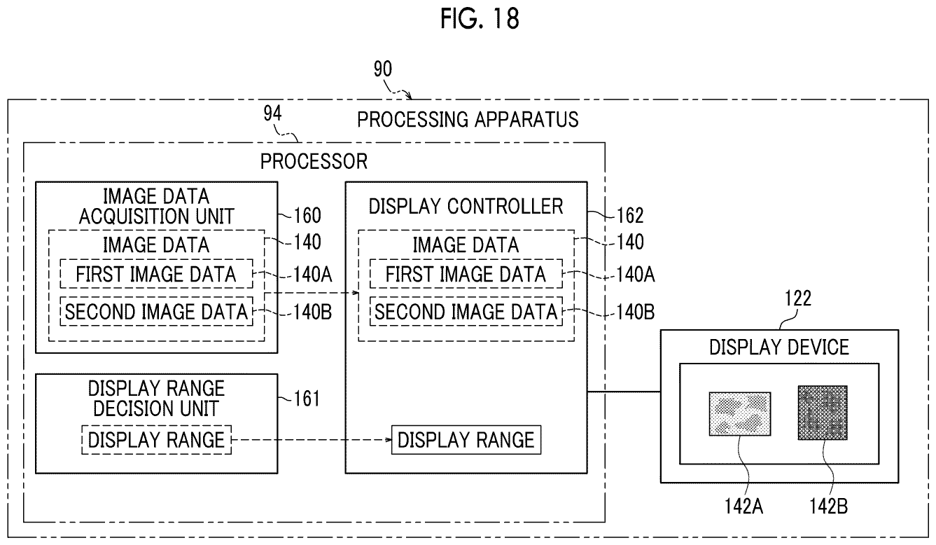

As an example, as shown in FIG. 18, the display controller 162 acquires the image data 140 acquired by the image data acquisition unit 160, and the display range decided by the display range decision unit 161. The display controller 162 performs control of displaying the image data 140 on the display device 122 in the acquired display range. As a result, the first contrast map 142A including the first subject 200A and the second contrast map 142B including the second subject 200B are displayed on the display device 122 in the display range decided by the display range decision unit 161.

In the examination processing executed after the display range is decided in the display range decision processing as described above, a new subject 200, which is an examination object, is imaged to acquire the imaging data 70, and the image data 140 is acquired through each step (see FIGS. 9 and 10) of the examination processing based on the acquired imaging data 70.

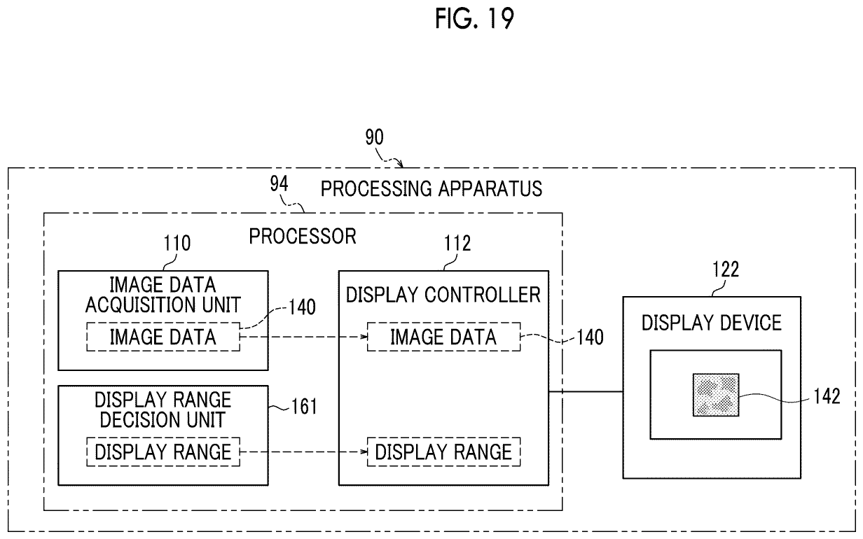

Then, as an example, as shown in FIG. 19, in the examination processing executed after the display range is decided in the display range decision processing, the display controller 112 acquires the image data 140 acquired by the image data acquisition unit 110, and the display range decided by the display range decision unit 161, and performs control of displaying the image data 140 on the display device 122 in the acquired display range. As a result, the contrast map 142 including the new subject 200, which is the examination object, is displayed on the display device 122 in the display range decided by the display range decision unit 161.

In the examination processing executed after the display range is decided in the display range decision processing, the new subject 200 imaged by the imaging apparatus 10 is an example of a “third subject” according to the technique of the present disclosure, and the contrast C corresponding to each image pixel included in the contrast map 142 corresponding to the new subject 200 is an example of a “third indicator” according to the technique of the present disclosure. In addition, in the examination processing executed after the display range is decided in the display range decision processing, the imaging data 70 acquired by the imaging data acquisition unit 102 is an example of “second imaging data” according to the technique of the present disclosure, and the image data 140 acquired by the image data acquisition unit 110 is an example of “second image data” according to the technique of the present disclosure.

It should be noted that, in the above description, an example is described in which the display range is decided for the image data 140, but the display condition other than the display range may be decided. In addition, in the above description, the display range is decided based on the difference between the first contrast representative value Ca and the second contrast representative value Cb, but the display range may be decided based on the relationship between the first subject 200A and the second subject 200B, in addition to the difference between the first contrast representative value Ca and the second contrast representative value Cb. In addition, for example, the relationship between the first subject 200A and the second subject 200B in this case may include the attributes, such as the types of the first subject 200A and the second subject 200B, or may include the imaging conditions, such as the lighting conditions for the first subject 200A and the second subject 200B.

In addition, in the above description, the display range is decided based on the relationship between the first subject 200A and the second subject 200B in the contrast map image 144, but the display range may be decided based on a relationship between the first subject 200A and the second subject 200B with respect to a subject imaged in the past by the imaging apparatus 10 (that is, a relationship in which actual objects are compared). The subject imaged in the past in this case may include a third subject of the same type as the first subject 200A and a fourth subject of the same type as the second subject 200B. Then, the display range may be decided based on a relationship between the first subject 200A and the third subject and/or a relationship between the second subject 200B and the fourth subject.

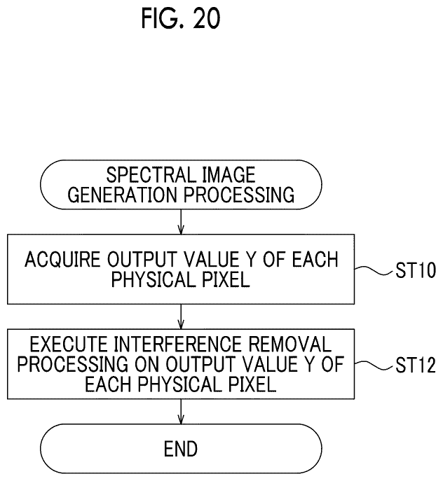

Hereinafter, actions of the examination system 130 according to the first embodiment will be described. First, the spectral image generation processing executed by the imaging apparatus 10 according to the first embodiment will be described. FIG. 20 shows an example of a flow of the spectral image generation processing according to the first embodiment.

In the spectral image generation processing shown in FIG. 20, first, in step ST10, the output value acquisition unit 82 acquires the output value Y of each physical pixel 44 based on the imaging data 70 output from the image sensor 28 (see FIG. 7). After the processing in step ST10 is executed, the spectral image generation processing proceeds to step ST12.

In step ST12, the interference removal processing unit 84 acquires the interference removal matrix A stored in the storage 62 and the output value Y of each physical pixel 44 acquired in step ST10, and outputs the pixel value X of each image pixel based on the interference removal matrix A and the output value Y of each physical pixel 44, which are acquired (see FIG. 7). By executing the interference removal processing in step ST12, the imaging data 70 is separated into the spectral image data 72A corresponding to the brightness value X_{λ1} of the first wavelength range polarized light, the spectral image data 72B corresponding to the brightness value X_{λ2} of the second wavelength range polarized light, and the spectral image data 72C corresponding to the brightness value X_{λ3} of the third wavelength range polarized light. After the processing in step ST12 is executed, the spectral image generation processing ends.

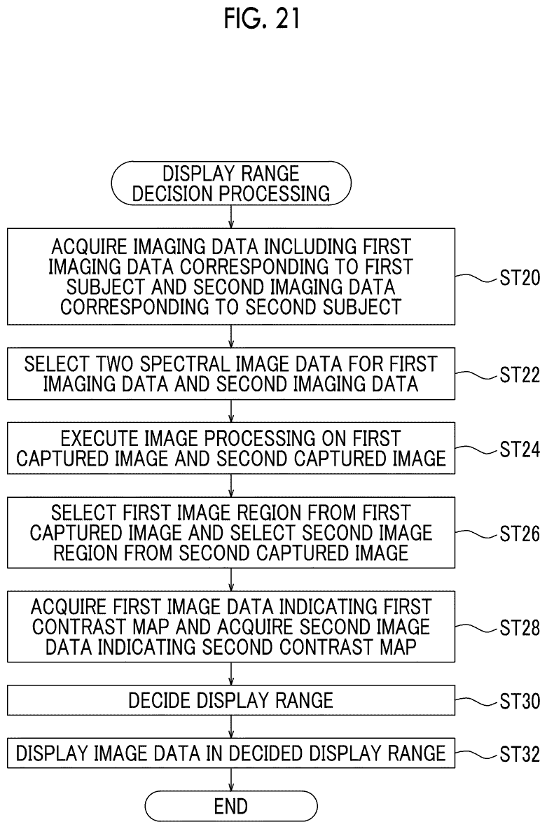

Subsequently, the display range decision processing executed by the processing apparatus 90 according to the first embodiment will be described. FIG. 21 shows an example of a flow of the display range decision processing according to the first embodiment.

In the display range decision processing shown in FIG. 21, first, in step ST20, the imaging data acquisition unit 152 acquires the imaging data 70 including the first imaging data 70A corresponding to the first subject 200A imaged by the imaging apparatus 10, and the second imaging data 70B corresponding to the second subject 200B imaged by the imaging apparatus 10 (see FIG. 15). After the processing in step ST20 is executed, the display range decision processing proceeds to step ST22.

In step ST22, the wavelength range selection unit 154 selects the two spectral image data 72 from among the plurality of spectral image data 72 for the first imaging data 70A and the second imaging data 70B which are acquired in step ST20 (see FIG. 16). After the processing in step ST22 is executed, the display range decision processing proceeds to step ST24.

In step ST24, the image processing unit 156 acquires the first imaging data 70A including the two spectral image data 72 selected in step ST22, and executes the image processing on the first captured image 74A indicated by the first imaging data 70A (see FIG. 16). The image processing unit 156 acquires the second imaging data 70B including the two spectral image data 72 selected in step ST22, and executes the image processing on the second captured image 74B indicated by the second imaging data 70B (see FIG. 16). After the processing in step ST24 is executed, the display range decision processing proceeds to step ST26.

In step ST26, the image region selection unit 158 selects the first image region 76A from the first captured image 74A on which the image processing is executed in step ST24 (see FIG. 17). The image region selection unit 158 selects the second image region 76B from the second captured image 74B on which the image processing is executed in step ST24 (see FIG. 17). After the processing in step ST26 is executed, the display range decision processing proceeds to step ST28.

In step ST28, the image data acquisition unit 160 acquires the first image data 140A indicating the first contrast map 142A from the first imaging data 70A in which the first image region 76A is selected in step ST26 (see FIG. 17). In addition, the image data acquisition unit 160 acquires the second image data 140B indicating the second contrast map 142B from the second imaging data 70B in which the second image region 76B is selected in step ST26 (see FIG. 17). After the processing in step ST28 is executed, the display range decision processing proceeds to step ST30.

In step ST30, the display range decision unit 161 decides the display range based on the first image data 140A and the second image data 140B which are acquired in step ST28 (see FIG. 17). After the processing in step ST30 is executed, the display range decision processing proceeds to step ST32.

In step ST32, the display controller 162 acquires the image data 140 including the first image data 140A and the second image data 140B which are acquired in step ST28, and the display range decided in step ST30, and performs control of displaying the image data 140 on the display device 122 in the acquired display range (see FIG. 18). Accordingly, the first contrast map 142A including the first subject 200A and the second contrast map 142B including the second subject 200B are displayed on the display device 122 in the display range decided in step ST30. After the processing in step ST32 is executed, the display range decision processing ends. It should be noted that the display range decision method executed by the display range decision processing described above is an example of a “display condition decision method” according to the technique of the present disclosure.

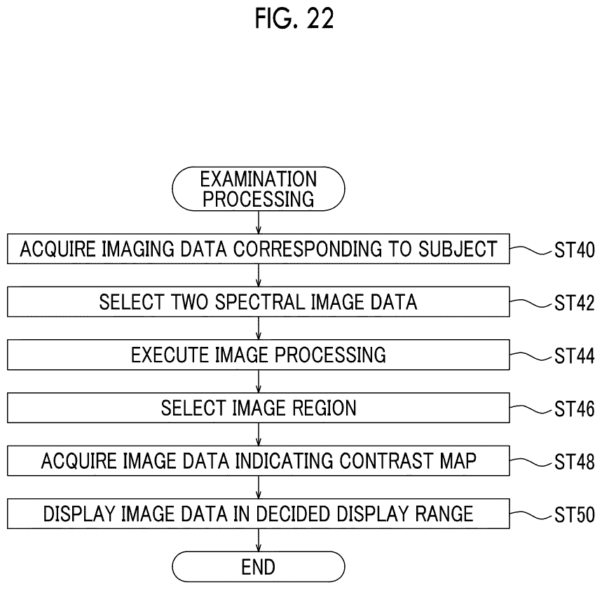

Subsequently, the examination processing executed by the processing apparatus 90 according to the first embodiment will be described. FIG. 22 shows an example of a flow of the examination processing according to the first embodiment.

In the examination processing shown in FIG. 22, first, in step ST40, the imaging data acquisition unit 102 acquires the imaging data 70 corresponding to the subject 200 imaged by the imaging apparatus 10 (see FIG. 9). After the processing in step ST40 is executed, the examination processing proceeds to step ST42.

In step ST42, the wavelength range selection unit 104 selects the two spectral image data 72 from among the plurality of spectral image data 72 included in the imaging data 70 acquired in step ST40 (see FIG. 9). After the processing in step ST42 is executed, the examination processing proceeds to step ST44.

In step ST44, the image processing unit 106 acquires the imaging data 70 including the two spectral image data 72 selected in step ST42, and executes the image processing on the captured image 74 indicated by the imaging data 70 (see FIG. 9). After the processing in step ST44 is executed, the examination processing proceeds to step ST46.

In step ST46, the image region selection unit 108 selects the image region 76 from the captured image 74 on which the image processing is executed in step ST44 (see FIG. 10). After the processing in step ST46 is executed, the examination processing proceeds to step ST48.

In step ST48, the image data acquisition unit 110 acquires the image data 140 indicating the contrast map 142 from the imaging data 70 in which the image region 76 is selected in step ST46 (see FIGS. 10 and 19). After the processing in step ST48 is executed, the examination processing proceeds to step ST50.

In step ST50, the display controller 112 acquires the image data 140 acquired in step ST48, and the display range decided in step ST30, and performs control of displaying the image data 140 on the display device 122 in the acquired display range (see FIG. 19). Accordingly, the contrast map 142 including the subject 200 is displayed on the display device 122 in the display range decided in step ST30. After the processing in step ST50 is executed, the examination processing ends. It should be noted that the examination method executed by the examination processing described above is an example of an “examination method” according to the technique of the present disclosure. In addition, the image display method of displaying the contrast map 142 including the subject 200 on the display device 122 in the display range decided in step ST30 is an example of an “image display method” according to the technique of the present disclosure.

Next, the effects of the first embodiment will be described.

As described above, in the processing apparatus 90 according to the first embodiment, the processor 94 acquires the imaging data 70 including the first subject 200A and the second subject 200B imaged by the imaging apparatus 10, and acquires the image data 140 including the first image data 140A indicating the first contrast map 142A corresponding to the first subject 200A and the second image data 140B indicating the second contrast map 142B corresponding to the second subject 200B, from the imaging data 70. Moreover, the processor 94 decides the display range of the image data 140 based on the difference between the first contrast representative value Ca included in the first contrast map 142A and the second contrast representative value Cb included in the second contrast map 142B. Therefore, for example, as compared with a case in which the display range is fixed to a predetermined display range or a case in which the display range is decided regardless of the relationship between the first subject 200A and the second subject 200B, it is possible to discriminate the difference between the first subject 200A and the second subject 200B. As a result, in the examination processing, it is possible to discriminate the goodness or badness of the subject 200.

Further, the difference between the first contrast representative value Ca and the second contrast representative value Cb indicates the relationship between the first subject 200A and the second subject 200B in the contrast map image 144 in a state in which the noise is included. Therefore, even in a case in which the contrast map image 144 includes the noise, the display range is decided to the display range corresponding to the difference between the first contrast representative value Ca and the second contrast representative value Cb, so that it is possible to discriminate the difference between the first subject 200A and the second subject 200B.

The image data 140 is generated based on the contrast C of the brightness of the light in the two wavelength ranges 2. Accordingly, it is possible to discriminate the difference between the first subject 200A and the second subject 200B based on the contrast C of the brightness of the light in the two wavelength ranges 2.

The two wavelength ranges 2 are selected based on the attributes of the first subject 200A and the second subject 200B. Accordingly, the contrast map images 144 corresponding to the attributes of the first subject 200A and the second subject 200B can be obtained.

The two wavelength ranges λ are selected based on the imaging conditions of the first subject 200A and the second subject 200B. Accordingly, the contrast map image 144 corresponding to the imaging conditions of the first subject 200A and the second subject 200B can be obtained.

The contrast map image 144 is an image on which the image processing and/or the arithmetic processing is executed. Accordingly, the visibility related to the difference between the first subject 200A and the second subject 200B can be enhanced as compared with a case in which the image processing and/or the arithmetic processing is not executed on the contrast map image 144.

In addition, the display range is selected from among the first display range and the second display range based on the magnitude of the difference between the first contrast representative value Ca and the second contrast representative value Cb. Accordingly, the display range can be decided to the display range corresponding to the magnitude of the difference between the first contrast representative value Ca and the second contrast representative value Cb.

### Second Embodiment

Hereinafter, a second embodiment of the technique of the present disclosure will be described.

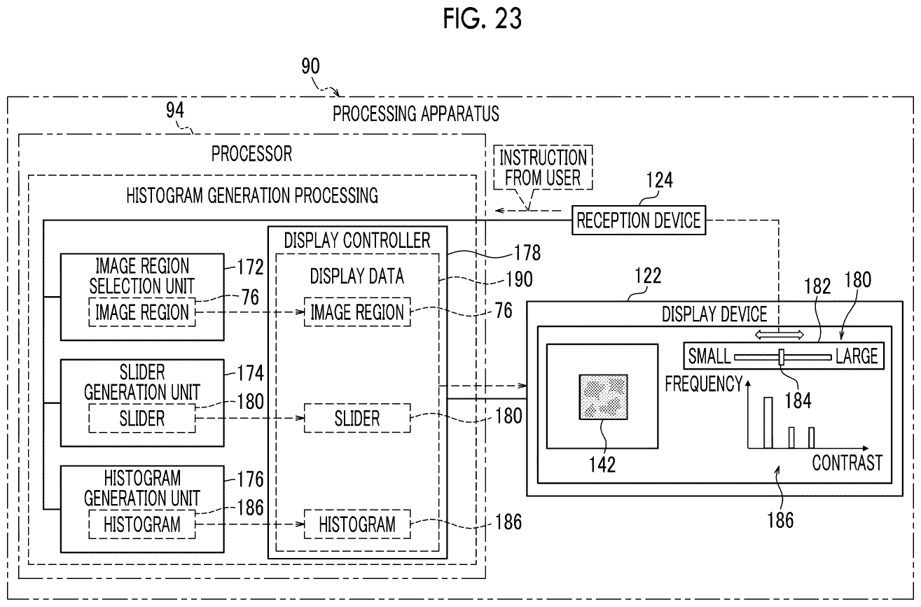

As shown in FIG. 23 as an example, in the second embodiment, the processor 94 executes histogram generation processing in a case in which the examination processing and/or the display range decision processing is executed. The histogram generation processing is executed, for example, by interrupt processing with respect to the examination processing and/or the display range decision processing. The histogram generation processing is realized by the processor 94 operating as an image region selection unit 172, a slider generation unit 174, a histogram generation unit 176, and a display controller 178.

It should be noted that the captured image 74 in the following description refers to any one of the captured image 74 acquired in the examination processing, the first captured image 74A acquired in the display range decision processing, or the second captured image 74B acquired in the display range decision processing.

In addition, the subject 200 in the following description refers to any one of the subject 200 in the examination processing, the first subject 200A in the display range decision processing, and the second subject 200B in the display range decision processing.

The slider generation unit 174 generates image data indicating a slider 180 displayed on the display device 122. The slider 180 is displayed on the display device 122. The slider 180 is a GUI for indicating the size of the image region 76 selected by the image region selection unit 172. The slider 180 includes a guide bar 182 and a slide bar 184.

In a case in which the reception device 124 receives an instruction to operate the slider 180 (that is, an instruction to change the position of the slide bar 184) from the user, the instruction from the user corresponding to the instruction received by the reception device 124 is output from the reception device 124 to the image region selection unit 172, the slider generation unit 174, and the histogram generation unit 176.

The slider generation unit 174 generates image data indicating the slider 180 in accordance with an instruction from the user. That is, the image data indicating the slider 180 of which the position of the slide bar 184 is changed to the position corresponding to the instruction from the user is generated.

The image region selection unit 172 selects the image region 76 in accordance with the instruction from the user. For example, a selection range of the image region 76 is expanded in accordance with the position of the slide bar 184 in a case in which the position of the slide bar 184 is changed to the “large” side, and the selection range of the image region 76 is reduced in accordance with the position of the slide bar 184 in a case in which the position of the slide bar 184 is changed to the “small” side. The image region selection unit 172 generates the image data indicating the image region 76.

The histogram generation unit 176 generates image data indicating a histogram 186 related to the image region 76 in accordance with the instruction from the user. The image data indicating the histogram 186 is an example of “histogram data” and “first histogram data” according to the technique of the present disclosure. As an example, the histogram 186 is a histogram related to a ratio of the contrast C of each image pixel included in the image region 76, and specifically, is a histogram indicating a relationship between the contrast C and a frequency.

It should be noted that, here, although an example is described in which the histogram indicating the relationship between the contrast C and the frequency is generated as an example of the histogram 186, another histogram related to the contrast C may be generated.

The display controller 178 generates display data 190 including the image data indicating the slider 180, the image data indicating the image region 76, and the image data indicating the histogram 186, and performs control of displaying the display data 190 on the display device 122. Accordingly, the image including the image region 76, the slider 180, and the histogram 186 is displayed on the display device 122.

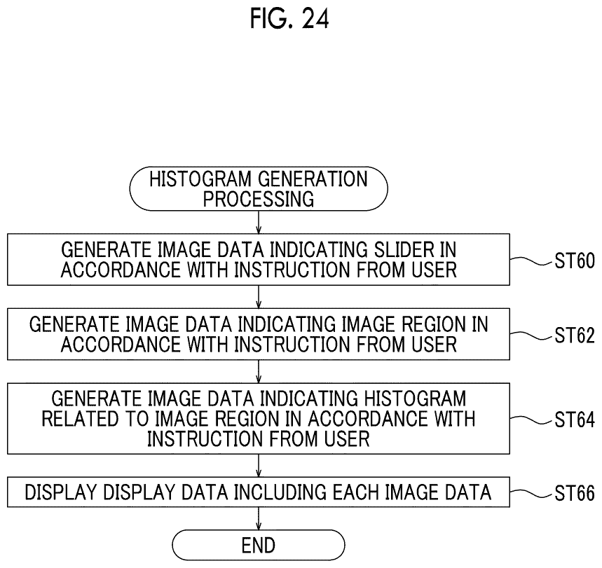

Hereinafter, actions of the examination system 130 according to the second embodiment will be described. FIG. 24 shows an example of a flow of the histogram generation processing according to the second embodiment.

In the histogram generation processing shown in FIG. 24, first, in step ST60, the slider generation unit 174 generates the image data indicating the slider 180 in accordance with the instruction from the user (see FIG. 23). After the processing in step ST60 is executed, the histogram generation processing proceeds to step ST62.

In step ST62, the image region selection unit 172 selects the image region 76 in accordance with the instruction from the user, and generates the image data indicating the selected image region 76 (see FIG. 23). After the processing in step ST62 is executed, the histogram generation processing proceeds to step ST64.

In step ST64, the histogram generation unit 176 generates the image data indicating the histogram 186 related to the image region 76 in accordance with the instruction from the user (see FIG. 23). After the processing in step ST64 is executed, the histogram generation processing proceeds to step ST66.

In step ST66, the display controller 178 generates the display data 190 including the image data indicating the slider 180, the image data indicating the image region 76, and the image data indicating the histogram 186, and performs control of displaying the display data 190 on the display device 122 (see FIG. 23). Accordingly, the image including the image region 76, the slider 180, and the histogram 186 is displayed on the display device 122. After the processing in step ST66 is executed, the histogram generation processing ends.

As described above, in the processing apparatus 90 according to the second embodiment, the processor 94 generates the image data indicating the histogram 186 indicating the relationship between the contrast C and the frequency of each image pixel for the image region 76 selected in accordance with the instruction from the user, and outputs the generated image data to the display device 122. Therefore, the histogram 186 is displayed on the display device 122, whereby the user can understand the ratio of the contrast C of each image pixel and the ratio of the good or bad region in the subject 200 for the selected image region 76.

It should be noted that, in the second embodiment, the image region 76 may be selected from the spectral image included in the captured image 74, and the histogram 186 related to the selected image region 76 may be generated. In addition, in this case, the histogram 186 may be a histogram indicating a ratio of the brightness of the wavelength component of the light emitted from the subject 200 (that is, a ratio of the brightness of each image pixel included in the spectral image). The histogram data indicating the ratio of the brightness is an example of “second histogram data” according to the technique of the present disclosure. With such a configuration, the histogram 186 is displayed on the display device 122, whereby the user can understand the ratio of the brightness of the wavelength component of the light emitted from the subject 200 for the selected image region 76.

### Third Embodiment

Hereinafter, a third embodiment of the technique of the present disclosure will be described.

In general, immediately after the start of the examination system 130, the characteristics of the light source 132 and/or the characteristics of the imaging apparatus 10 may be unstable. That is, the characteristics (hereinafter, referred to as “characteristics of the light source 132”) depending on a difference in the intensity of the light applied from the light source 132 for each wavelength and/or a position of the light source 132 are changed with time. In addition, the characteristics (hereinafter, referred to as “characteristics of the imaging apparatus 10”) depending on a difference in the sensitivity of the imaging apparatus 10 for each wavelength and/or a position of the imaging apparatus 10 are also changed with time. Accordingly, there is a possibility that the contrast C is changed with time after the examination system 130 is started. Therefore, it is desirable to perform calibration on the imaging apparatus 10 after the examination system 130 is started. It should be noted that, since the characteristics of the light source 132 and/or the imaging apparatus 10 are changed with time due to the temperature and the humidity of the imaging apparatus 10 and/or the imaging environment, in addition to the deterioration with age, the calibration may be performed in accordance with the start time of the light source 132 and/or the imaging apparatus 10. In addition to the start time, the calibration may be performed by using a change in the temperature and the humidity as a trigger.

The calibration is executed by imaging a white reference plate with the imaging apparatus 10 and is based on the imaging data obtained by the imaging. By the calibration, the characteristics of the light source 132 and the characteristics of the imaging apparatus 10 are reset to a state in a case in which the white reference plate is imaged. It should be noted that, in order to prevent the white reference plate from being contaminated or to prevent the calibration from being performed on a plate other than the white reference plate, a detector that detects the contamination and/or the presence or absence of the color unevenness of the white reference plate for the calibration may be provided, and a warning may be issued from the examination system 130 in a case in which an abnormality is detected.

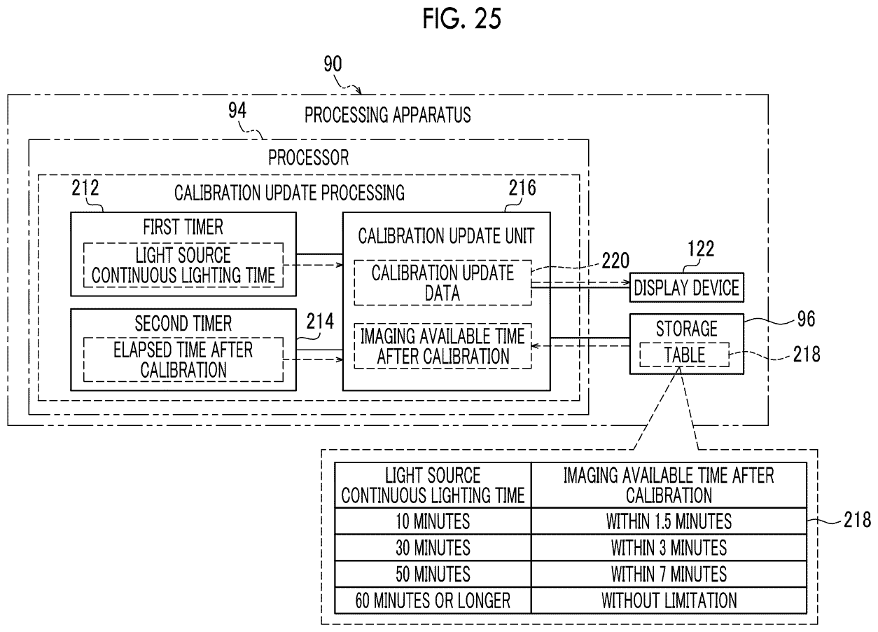

As shown in FIG. 25 as an example, in the third embodiment, the processor 94 executes calibration update processing in a case in which the examination processing and/or the display range decision processing is executed. The calibration update processing is executed, for example, by interrupt processing with respect to the examination processing and/or the display range decision processing. The calibration update processing is realized by the processor 94 operating as a first timer 212, a second timer 214, and a calibration update unit 216.

The first timer 212 counts a time during which the light source 132 is continuously lighted (hereinafter, referred to as “light source continuous lighting time”). The second timer 214 counts an elapsed time after the calibration is executed (hereinafter, referred to as “elapsed time after the calibration”). The first timer 212 and the second timer 214 are examples of a “plurality of timers” according to the technique of the present disclosure. The light source continuous lighting time and the elapsed time after the calibration are examples of “values of the plurality of timers” according to the technique of the present disclosure.

The storage 96 stores a table 218. The table 218 defines a relationship between the light source continuous lighting time and an imaging available time after the calibration. FIG. 25 shows specific numerical values of the light source continuous lighting time and the imaging available time after the calibration, but the numerical values are merely examples, and may be other numerical values than the examples. The imaging available time after the calibration is set to a time in a case in which the characteristics of the light source 132 and/or the characteristics of the imaging apparatus 10 reach an upper limit value of an allowable range in executing the examination processing and/or the display range decision processing with the lapse of time. That is, the examination processing and/or the display range decision processing can be executed under appropriate conditions corresponding to each processing within the imaging available time after the calibration.

The calibration update unit 216 sequentially acquires the light source continuous lighting time and the elapsed time after the calibration. Subsequently, the calibration update unit 216 acquires the imaging available time after the calibration corresponding to the light source continuous lighting time based on the table 218. Subsequently, the calibration update unit 216 determines whether the elapsed time after the calibration exceeds the imaging available time after the calibration.

In a case in which the elapsed time after the calibration exceeds the imaging available time after the calibration, the calibration update unit 216 generates calibration update data 220 related to the update of the calibration. The calibration update data 220 is data indicating, for example, a message and the like for prompting the user to execute the calibration. The calibration update data 220 is an example of “update data” according to the technique of the present disclosure.

Then, in a case in which the calibration update unit 216 generates the calibration update data 220, the calibration update unit 216 outputs the calibration update data 220 to the display device 122. As a result, the message and the like prompting the user to execute the calibration are displayed on the display device 122.

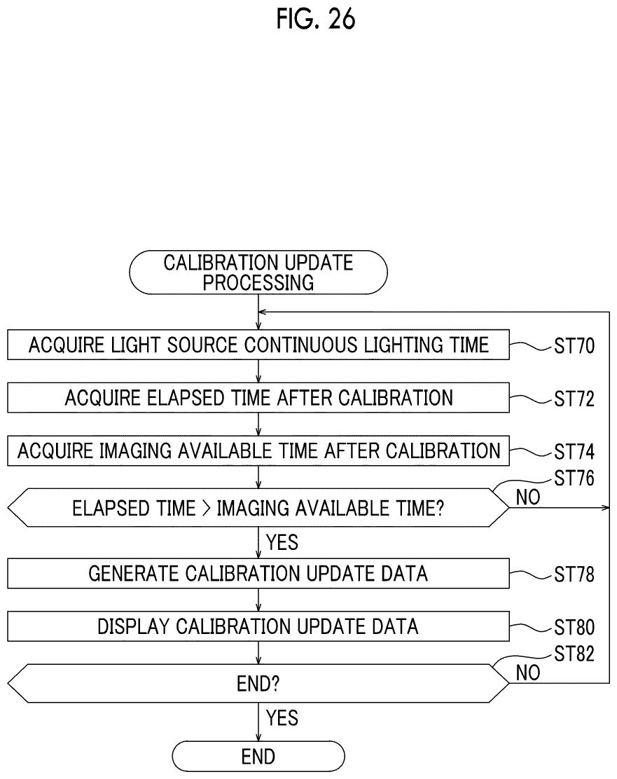

Hereinafter, actions of the examination system 130 according to the third embodiment will be described. FIG. 26 shows an example of a flow of the calibration update processing according to the third embodiment.

In the calibration update processing shown in FIG. 26, first, in step ST70, the calibration update unit 216 acquires the light source continuous lighting time counted by the first timer 212 (see FIG. 25). After the processing in step ST70 is executed, the calibration update processing proceeds to step ST72.

In step ST72, the calibration update unit 216 acquires the elapsed time after the calibration counted by the second timer 214 (see FIG. 25). After the processing in step ST70 is executed, the calibration update processing proceeds to step ST72.

In step ST74, the calibration update unit 216 acquires the imaging available time after the calibration corresponding to the light source continuous lighting time acquired in step ST70 based on the table 218 (see FIG. 25). After the processing in step ST74 is executed, the calibration update processing proceeds to step ST76.

In step ST76, the calibration update unit 216 determines whether the elapsed time after the calibration acquired in step ST72 exceeds the imaging available time after the calibration acquired in step ST74 (see FIG. 25). In step ST76, in a case in which the elapsed time after the calibration exceeds the imaging available time after the calibration, an affirmative determination is made, and the calibration update processing proceeds to step ST78. In step ST76, in a case in which the elapsed time after the calibration does not exceed the imaging available time after the calibration, a negative determination is made, and the calibration update processing proceeds to step ST70.

In step ST78, the calibration update unit 216 generates the calibration update data 220 (see FIG. 25). After the processing in step ST78 is executed, the calibration update processing proceeds to step ST80.

In step ST80, the calibration update unit 216 outputs the calibration update data 220 to the display device 122 (see FIG. 25). As a result, the message and the like prompting the user to execute the calibration are displayed on the display device 122. After the processing in step ST80 is executed, the calibration update processing proceeds to step ST82.

In step ST82, the processor 94 determines whether a condition for ending the calibration update processing (hereinafter, referred to as “end condition”) is established. Examples of the end condition include a condition in which the examination processing and/or the display range decision processing ends. In a case in which the end condition is not established, the calibration update processing proceeds to step ST70. In a case in which the end condition is established, the calibration update processing ends.

As described above, in the processing apparatus 90 according to the third embodiment, the processor 94 acquires the light source continuous lighting time counted by the first timer 212, and the elapsed time after the calibration counted by the second timer 214, and outputs the calibration update data 220 related to the update of the calibration to the display device 122 based on the light source continuous lighting time and the elapsed time after the calibration. Therefore, in a case in which the user executes the calibration on the imaging apparatus 10 based on the message and the like displayed on the display device 122, the measurement accuracy of the brightness of the light in the two wavelength ranges λ can be improved as compared with a case in which the calibration is not executed.

It should be noted that techniques that can be combined among the plurality of techniques described in the first to third embodiments may be combined as appropriate.

Further, in the embodiment described above, although the processor 60 is shown for the imaging apparatus 10, at least one other CPU, at least one other GPU, and/or at least one other TPU may be included instead of the processor 60 or together with the processor 60.

Further, in the embodiment described above, although the processor 94 is shown for the processing apparatus 90, at least one other CPU, at least one other GPU, and/or at least one other TPU may be included instead of the processor 94 or together with the processor 94.

In addition, in the embodiment described above, the form example is described in which the examination program 100 and the display range decision program 150 are stored in the storage 96 of the processing apparatus 90, but the technique of the present disclosure is not limited to this. For example, the examination program 100 and/or the display range decision program 150 may be stored in the storage 62 of the imaging apparatus 10, and the examination program 100 and/or the display range decision program 150 may be executed by the processor 60 of the imaging apparatus 10.

In the embodiment described above, although the form example is described in which the spectral image generation program 80 is stored in the storage 62 for the imaging apparatus 10, the technique of the present disclosure is not limited to this. For example, the spectral image generation program 80 may be stored in a portable non-transitory computer-readable storage medium, such as an SSD or a USB memory (hereinafter, simply referred to as “non-transitory storage medium”). The spectral image generation program 80 stored in the non-transitory storage medium may be installed in the computer 56 of the imaging apparatus 10.

Further, the spectral image generation program 80 may be stored in a storage device of another computer, server apparatus, or the like that is connected to the imaging apparatus 10 via a network, and the spectral image generation program 80 may be downloaded in response to a request from the imaging apparatus 10 and may be installed in the computer 56 of the imaging apparatus 10.

In addition, it is not necessary to store the entire spectral image generation program 80 in the storage device of another computer, server apparatus, or the like that is connected to the imaging apparatus 10, or the storage 62, and a part of the spectral image generation program 80 may be stored therein.

In addition, in the embodiment described above, the form example is described in which the examination program 100 and the display range decision program 150 are stored in the storage 96 for the processing apparatus 90, but the technique of the present disclosure is not limited to this. For example, the examination program 100 and/or the display range decision program 150 may be stored in the non-transitory storage medium. The examination program 100 and/or the display range decision program 150 stored in the non-transitory storage medium may be installed in the computer 92 of the processing apparatus 90.

In addition, the examination program 100 and/or the display range decision program 150 may be stored in the storage device of another computer, server apparatus, or the like connected to the processing apparatus 90 via the network, and the examination program 100 and/or the display range decision program 150 may be downloaded in response to a request of the processing apparatus 90 and may be installed in the computer 92 of the processing apparatus 90.

In addition, it is not necessary to store the entire examination program 100 and/or the entire display range decision program 150 in the storage device of another computer, server apparatus, or the like that is connected to the processing apparatus 90, or the storage 96, and a part of the examination program 100 and/or a part of the display range decision program 150 may be stored therein.

Although the computer 56 is built in the imaging apparatus 10, the technique of the present disclosure is not limited to this, and for example, the computer 56 may be provided outside the imaging apparatus 10.

Although the computer 92 is built in the processing apparatus 90, the technique of the present disclosure is not limited to this, and for example, the computer 92 may be provided outside the processing apparatus 90.

In addition, in the embodiment described above, although the computer 56 including the processor 60, the storage 62, and the RAM 64 is shown for the imaging apparatus 10, the technique of the present disclosure is not limited to this, and a device including an ASIC, an FPGA, and/or a PLD may be applied instead of the computer 56. Also, a combination of a hardware configuration and a software configuration may be used instead of the computer 56.

In addition, in the embodiment described above, although the computer 92 including the processor 94, the storage 96, and the RAM 98 is shown for the processing apparatus 90, the technique of the present disclosure is not limited to this, and a device including an ASIC, an FPGA, and/or a PLD may be applied instead of the computer 92. Also, a combination of a hardware configuration and a software configuration may be used instead of the computer 92.

Further, the following various processors can be used as a hardware resource for executing the various types of processing described in the embodiment described above. Examples of the processor include a CPU which is a general-purpose processor functioning as the hardware resource for executing the various types of processing by executing software, that is, a program. Moreover, examples of the processor include a dedicated electronic circuit which is a processor having a circuit configuration designed to be dedicated for executing specific processing, such as the FPGA, the PLD, or the ASIC. A memory is built in or connected to any processor, and any processor executes the various types of processing by using the memory.

The hardware resource for executing various types of processing may be configured by one of the various processors or may be configured by a combination of two or more processors that are the same type or different types (for example, combination of a plurality of FPGAs or combination of a CPU and an FPGA). Moreover, the hardware resource for executing the various types of processing may be one processor.

As a configuring example of one processor, first, there is a form in which one processor is configured by a combination of one or more CPUs and software and the processor functions as the hardware resource for executing the various types of processing. Secondly, as represented by SoC, there is a form in which a processor that realizes the functions of the entire system including a plurality of hardware resources for executing various types of processing with one IC chip is used. As described above, the various types of processing are realized by using one or more of various processors as the hardware resource.

Further, as the hardware structure of these various processors, more specifically, it is possible to use an electronic circuit in which circuit elements, such as semiconductor elements, are combined. In addition, the processing described above is merely an example. Accordingly, it is needless to say that unnecessary steps may be deleted, new steps may be added, or the processing order may be changed within a range that does not deviate from the gist.

The description contents and the shown contents above are the detailed description of the parts according to the technique of the present disclosure, and are merely examples of the technique of the present disclosure. For example, the above description of the configuration, the functions, the actions, and the effects are the description of examples of the configuration, the functions, the actions, and the effects of the parts according to the technique of the present disclosure. Accordingly, it is needless to say that unnecessary parts may be deleted, new elements may be added, or replacements may be made with respect to the description contents and the shown contents above within a range that does not deviate from the gist of the technique of the present disclosure. In addition, in order to avoid complications and facilitate understanding of the parts according to the technique of the present disclosure, in the description contents and the shown contents above, the description of common technical knowledge and the like that do not particularly require description for enabling the implementation of the technique of the present disclosure are omitted.

In the present specification, “A and/or B” is synonymous with “at least one of A or B”. That is, “A and/or B” means that it may be only A, only B, or a combination of A and B. In addition, in the present specification, in a case in which three or more matters are associated and expressed by “and/or”, the same concept as “A and/or B” is applied.

All documents, patent applications, and technical standards described in the present specification are incorporated into the present specification by reference to the same extent as in a case in which the individual documents, patent applications, and technical standards are specifically and individually stated to be described by reference.

Regarding the embodiment described above, the following supplementary notes are disclosed.

### Supplementary Note 1

An image display method comprising: displaying first image data in accordance with a display condition decided by the display condition decision method according to any one of the first to thirty-seventh aspects.

### Supplementary note 2

An Image Display Method Comprising: Acquiring Second Imaging Data by Imaging a third subject by a spectral imaging apparatus; acquiring second image data indicating a third indicator corresponding to the third subject based on the second imaging data; and displaying the second image data in accordance with a display condition decided by the display condition decision method according to any one of the first to thirty-seventh aspects.

What is claimed is:

1. A display condition decision method comprising:
acquiring first imaging data including a first subject and a second subject imaged by a spectral imaging apparatus;
acquiring first image data indicating an indicator related to discrimination between the first subject and the second subject from the first imaging data; and
deciding a display condition of the first image data based on a relationship between the first subject and the second subject.

2. The display condition decision method according to claim 1,
wherein the display condition includes a display range.

3. The display condition decision method according to claim 1,
wherein the indicator is an indicator based on a brightness of light in a plurality of wavelength ranges.

4. The display condition decision method according to claim 3,
wherein the plurality of wavelength ranges are selected from a combination.

5. The display condition decision method according to claim 3,
wherein the plurality of wavelength ranges are selected based on attributes of the first subject and the second subject.

6. The display condition decision method according to claim 3,
wherein the plurality of wavelength ranges are selected based on imaging conditions of the first subject and the second subject.

7. The display condition decision method according to claim 6,
wherein the imaging condition includes a lighting condition.

8. The display condition decision method according to claim 1,
wherein the indicator includes a contrast of a brightness of light in a plurality of wavelength ranges.

9. The display condition decision method according to claim 1,
wherein the indicator includes a normalized difference vegetation index.

10. The display condition decision method according to claim 1,
wherein the relationship includes a relationship between the first subject and the second subject in an image indicated by the first image data.

11. The display condition decision method according to claim 10,
wherein the relationship between the first subject and the second subject in the image includes a relationship in a state in which the image includes noise.

12. The display condition decision method according to claim 1,
wherein the relationship includes attributes of the first subject and the second subject.

13. The display condition decision method according to claim 1,
wherein the relationship includes imaging conditions of the first subject and the second subject.

14. The display condition decision method according to claim 1,
wherein the relationship includes a relationship of the indicator between the first subject and the second subject.

15. The display condition decision method according to claim 14,
wherein the indicator includes
a first indicator corresponding to the first subject, and
a second indicator corresponding to the second subject, and
the relationship of the indicator includes a relationship based on a degree of difference between the first indicator and the second indicator.

16. The display condition decision method according to claim 10,
wherein the relationship includes a relationship in a state in which image processing is executed on the image.

17. The display condition decision method according to claim 16,
wherein the image processing includes processing related to noise included in the image.

18. The display condition decision method according to claim 17,
wherein the processing related to the noise includes edge enhancement processing and/or noise reduction processing.

19. The display condition decision method according to claim 10,
wherein the relationship includes a relationship in a state in which arithmetic processing is executed on the image.

20. The display condition decision method according to claim 19,
wherein the arithmetic processing includes processing related to visibility of the image.

21. The display condition decision method according to claim 20,
wherein the processing related to the visibility includes gradation processing and/or gamma-correction processing.

22. The display condition decision method according to claim 1,
wherein the relationship includes a relationship between the first subject and the second subject with respect to a subject imaged in the past by the spectral imaging apparatus.

23. The display condition decision method according to claim 1,
wherein deciding the display condition includes selecting the display condition from among a plurality of display conditions based on the relationship.

24. The display condition decision method according to claim 23,
wherein the indicator includes
a first indicator corresponding to the first subject, and
a second indicator corresponding to the second subject,
the relationship includes a relationship based on a degree of difference between the first indicator and the second indicator, and
selecting the display condition from among the plurality of display conditions is performed based on a relationship between the degree of difference and a threshold value.

25. The display condition decision method according to claim 24,
wherein, in a case in which the degree of difference is larger than the threshold value,
an upper limit value of the display condition is decided based on a larger indicator out of the first indicator and the second indicator, and
a lower limit value of the display condition is decided based on a smaller indicator out of the first indicator and the second indicator.

26. The display condition decision method according to claim 25,
wherein the upper limit value of the display condition is decided based on the larger indicator and a first correction value, and
the lower limit value of the display condition is decided based on the smaller indicator and a second correction value.

27. The display condition decision method according to claim 26,
wherein the first correction value and the second correction value are decided based on noise included in an image indicated by the first image data.

28. The display condition decision method according to claim 24,
wherein, in a case in which the degree of difference is equal to or smaller than the threshold value,
a difference between an upper limit value and a lower limit value of the display condition is decided as the threshold value.

29. The display condition decision method according to claim 28,
wherein the upper limit value and the lower limit value of the display condition are decided based on an average value of the first indicator and the second indicator.

30. The display condition decision method according to claim 29,
wherein the upper limit value of the display condition is decided based on the average value and a third correction value, and
the lower limit value of the display condition is decided based on the average value and a fourth correction value.

31. The display condition decision method according to claim 30,
wherein the third correction value and the fourth correction value are decided based on noise included in an image indicated by the first image data.

32. The display condition decision method according to claim 1,
wherein the spectral imaging apparatus is a multispectral camera.

33. The display condition decision method according to claim 32,
wherein the first imaging data includes spectral image data corresponding to light in a plurality of wavelength ranges.

34. The display condition decision method according to claim 1,
wherein the second subject is a subject having a larger indicator than the first subject.

35. The display condition decision method according to claim 1,
wherein the first image data is image data in which the indicator is displayed by a heat map.

36. The display condition decision method according to claim 1,
wherein acquiring the first image data is performed based on a selected region of the first subject and/or the second subject.

37. The display condition decision method according to claim 1,
wherein the discrimination includes discrimination of goodness or badness of the first subject and the second subject.

38. A display condition decision apparatus comprising:
a processor,
wherein the processor
acquires first imaging data including a first subject and a second subject imaged by a spectral imaging apparatus,
acquires first image data indicating an indicator related to discrimination between the first subject and the second subject from the first imaging data, and
decides a display condition of the first image data based on a relationship between the first subject and the second subject.

39. The display condition decision apparatus according to claim 38,
wherein the processor
acquires values of a plurality of timers related to calibration of the spectral imaging apparatus, and
outputs update data related to update of the calibration based on the values.

40. The display condition decision apparatus according to claim 38,
wherein the processor outputs histogram data related to the indicator based on the first imaging data.

41. The display condition decision apparatus according to claim 40,
wherein the histogram data includes first histogram data indicating a ratio of the indicator.

42. The display condition decision apparatus according to claim 40,
wherein the histogram data includes second histogram data indicating a ratio of a brightness of a wavelength component of light emitted from the first subject and/or the second subject.

43. The display condition decision apparatus according to claim 40,
wherein the histogram data is displayed based on a selected region of the first subject and/or the second subject.

44. A non-transitory computer-readable storage medium storing a program for causing a computer to execute a process comprising:
acquiring first imaging data including a first subject and a second subject imaged by a spectral imaging apparatus;
acquiring first image data indicating an indicator related to discrimination between the first subject and the second subject from the first imaging data; and
deciding a display condition of the first image data based on a relationship between the first subject and the second subject.
